(19) United States
(12) Patent Application Publication
(10) Pub. No.: US 2018/0204192 A1
(43) Pub. Date: Jul. 19, 2018

(54) Secure Digital Data Operations

(71) Applicant: Barclays Bank PLC, London (GB)

(72) Inventors: Andrew Whaley, Cheshire (GB); Andrew Crichton, Cheshire (GB)

(21) Appl. No.: 15/742,629

(22) PCT Filed: Jul. 8, 2016
(86) PCT No.: PCT/GB2016/052073

§ 371 Date: Jan. 8, 2018

(30) Foreign Application Priority Data
Jul. 8, 2015 (GB) 1511963.9

(51) Int. Cl. G06Q 20/06; G06Q 20/10; G06Q 20/22; G06Q 20/36; G06Q 20/38; G06Q 20/40

(52) U.S. Cl. CPC G06Q 20/0658; G06Q 20/10; G06Q 20/223; G06Q 2220/10; G06Q 20/389; G06Q 20/401; G06Q 20/36

(57) ABSTRACT

Method and system for creating an amount of digital currency comprising generating a currency create signature by cryptographically signing currency data using at least a currency creator secret key. generating verifiable create data suitable for addition to a digital currency ledger, wherein the create data comprises the currency data and the currency create signature, the currency data comprising a value of the amount of new digital currency and currency key data based at least in part on a currency public key, wherein the currency public key corresponds to the amount of digital currency.

### TECHNICAL FIELD

The present disclosure relates to methods, systems and apparatus for a digital currency system. In accordance with aspects of the present disclosure, technical effects such improvements in efficiency resulting from a reduction in data processing and transfer requirements, as well as improvements in transactional security, may be achieved.

### BACKGROUND

Cryptocurrencies are digital currencies that are a form of alternative currency (or private currency). They are distinct from centrally controlled government-issued currencies (for example, fiat money) and offer a decentralised form of currency and/or medium of exchange. Digital currencies may be transacted or transferred from one owner to another and may be used for everyday purposes, such as buying goods or services, or be restricted for use by particular groups, for example within an on-line game. As such, digital currencies represent an alternative to traditional currencies.

One example of a cryptocurrency is bitcoin, although many other cryptocurrency systems have been devised. Bitcoin was developed by Satoshi Nakamoto and the original paper, ‘Bitcoin: A Peer-to-Peer Electronic Cash System’, outlining the fundamentals of bitcoin may be found at https://bitcoin.org/bitcoin.pdf.

An owner of bitcoins can spend bitcoins associated with a specific address. The address, or account, is a public key and the owner of the bitcoins associated with that address has a private key corresponding to the public key. In order to transfer the bitcoins to a new address (for example, to transfer the bitcoins to a payee associated with the new address) the payer must create a transaction for addition to a public ledger called a block chain.

FIG. 1 shows a representation of a bitcoin transaction. A transaction 90 comprises: the address (public key) of the payer; a hash 92 of the previous transaction 94 (i.e., the transaction by which the payer obtained the bitcoins associated with the address of the payer) and the address 96 (public key) of the payee; and a digital signature 98 of that hash. The digital signature 98 is created by signing the hash 92 using the payer's private key 99 (which corresponds to the address, or public key, of the payer).

The transaction has an input and an output. The input is the amount input to the transaction by the payer and may be considered to be represented by the payer's address, or public key, associated with the input amount and the value (for example 1 bitcoin (BTC), 4.5 BTCS, 13.67 BTCs etc) of the input amount. The output is the amount output from the transaction to the payee and may be considered to be represented by the payee's address, or public key, to which they would like the amount to be paid and the value of the output amount.

A transaction may have multiple inputs, whereby the payer has two or more addresses, or public keys, each associated with a different amount of bitcoins. In this case, each input amount may be considered to be represented by an address, or public key, associated with the input amount, and the value of the input amount. Likewise, a transaction may have multiple outputs, whereby two or more amounts are paid to two or more different payee addresses, or public keys. In this case, each output amount may be considered to be represented by an address, or public key, and the value of the output amount. In this way, a payer having a collection of bitcoins, some associated with one address, or public key, and others associated with another address, or public key, may spend them all in a single transaction. Likewise, by including multiple outputs, multiple payments may be made in one go (for example, where the total input is greater than the amount the payer wishes to pay to the payee, a first output amount may be to the value that is to be paid to the payee, and a second output amount may be to a value that is the change from the transaction, which goes to an address, or public key, associated with the payer).

The payer publically broadcasts the transaction to a network of communicating nodes, or miners. Nodes will group together transactions into a block and each node will then work on finding a so-called ‘proof of work’. The ‘proof of work’ is a number (or nonce) that has a value such that when the contents of the new block are hashed with the nonce, the result is numerically smaller than the network's difficulty target. When a node finds a proof-of-work, they add it to their block and broadcast the block to all nodes. The new block also contains information that “chains” it to the previous block—a cryptographic hash of the previous block, using the SHA-256 algorithm.

Each individual node cannot on its own be trusted. Therefore, every entity in bitcoin, including mining nodes and non-mining users, must perform their own full validation of the new block to ensure that every transaction is made up of valid inputs. This requires each entity to obtain a full copy of the block chain.

The block chain is a public ledger that records all bitcoin transactions. Each of the entities has a copy of the entire block chain, which they may use to verify the new block by checking that all transactions in it are valid and not already spent, for example by checking for each transaction that the payer's signature is correct and that according to block chain, the input amount(s) has not already been spent by the payer in an earlier transaction.

If a new block is accepted by a node, they will signal this by working on creating the next block in the chain, using the hash of the accepted block as the previous block. Thus, the accepted block is added to the block chain. New blocks are added to the block chain approximately six times an hour. Owing to the risk that a new block may be broadcast by a malicious entity and that a fork in the block chain may temporarily occur, where one fork contains the malicious new block and the other fork contains a reliable new block, in order to trust a block, it is advisable to wait until a number of later blocks are chained to it. Typically, it is suggested that after six further blocks have been added to the block chain, a block can be trusted. This may take approximately one hour, which may cause a considerable delay in a transaction being trusted by the parties involved in the transaction, thereby slowing down other activities (for example, the transfer of goods being purchased by virtue of the transaction).

In order to verify a new block, for example to check that an input to a transaction has not already been spent, each entity must have a copy of the entire block chain. This means that a new entity on the network must download the entire block chain, which is a significant amount of data, particularly for entities operating on low bandwidth data connections and/or entities with low processing powers (such as mobile devices, like mobile telephones, tablet computers, laptop computers, etc.). For some, this may represent a barrier to the adoption of bitcoin as new entities, such as a new payee that wishes to check that their transaction has been included in a block in the block chain and that the output amount has not previously been spent by the payer, or a new node/miner that wishes to take part in verifying new blocks. Furthermore, since a new block is added to the block chain approximately six times an hour, the size of the block chain is ever increasing, which means that this barrier is ever increasing.

For a number of users of bitcoin, anonymity is important. By anonymity, we mean the ability for a user to hold bitcoins to a total value that cannot be determined by third parties by referring to the block chain (which is publically published).

In order to provide anonymity for users, it is generally advised that for each transaction for which a user is a payee, they should generate a new address, or public key. That is to say, every time a user wishes to receive an amount of bitcoins from another entity, they should generate a new public-private key pair for the amount that they wish to receive and then provide the public key to the payer so that it can be used as the address for the output of the transaction. This means that when a user receives a number of different payments in different transactions, the block chain will not identify a single address to which all the payments are being made, which may be linked back to the entity (for example, when the user pays someone else from that address, that someone else may be able to link the address to the user because they personally know the user with whom they are dealing). Instead, the block chain will identify a different recipient address for each payment, such that even if one of the addresses can be linked back to the user, it will not be possible to determine the total number of bitcoins the user holds because their bitcoins are kept across a range of addresses, with no public link between the addresses.

However, generating a new public-private key pair for each new transaction may be inconvenient and time consuming for some users. Furthermore, it means that a payee that has received money from a large number of transactions over time must keep track of all of the different public-private key pairs and securely store all of the private keys. This can be a significant organisational overhead for some users of bitcoin.

Another issue encountered by some users of bitcoin is the outcome of losing their private key(s). A transaction can only take place if the payer has the private key associated with the amount that they wish to input to a transaction. Without a signature correctly generated using the correct private key, a transaction cannot be authenticated and will not be accepted onto the block chain. Users may store their public-private key pairs in a variety of different ways, for example electronically on an electronic device, or physically on a piece of paper, etc. However, if a user loses their keys (for example, by misplacing the physical device or means on which they are stored and/or by losing access to the electronic location in which they are stored) they will irretrievably lose the amounts associated with those keys. Thus, keeping currency in bitcoin may represent a significant risk for a number of users and potential users.

Another example of a cryptocurrency is Cryptonite. The Cryptonite system is similar to bitcoin, but utilises a Mini-Blockchain scheme in place of the block chain used in bitcoin. The Mini-Blockchain scheme is designed to eliminate the need to obtain and store a full block chain. The Mini-Blockchain scheme comprises a mini-blockchain, an account tree and a proof-chain.

The account tree is effectively a self-contained balance sheet to keep a record of the balance associated with all non-empty addresses (public keys). When a new block is added to the mini-blockchain, the balances recorded in the account tree are updated accordingly and a master hash of the account tree is embedded into the block header of the new block on the mini-blockchain in order to protect the account tree from malicious changes.

The mini-blockchain is essentially the same as the block chain of bitcoin, but because of the account tree, it is not necessary to keep a copy of all historic transactions. Thus, periodically, old blocks may be discarded from the mini-blockchain in order to minimise its size. However, to secure the system from attackers, the proof chain keeps a chain of interlocking proof-of-work solutions, which is a chain of block headers. The chain of block headers feeds into the mini-blockchain and acts to secure it and the account tree against attackers, even without a record of the old transactions.

Whilst the Mini-Blockchain scheme enables the block chain to be reduced in size by allowing old blocks to be discarded, the scheme introduces additional complexity by also requiring an account tree and a proof-chain to be maintained.

### SUMMARY

The present disclosure provides a method for creating an amount of digital currency, the method comprising: generating a currency create signature by cryptographically signing currency data using at least a currency creator secret key; and generating verifiable create data suitable for addition to a digital currency ledger (for example, a block chain), wherein the create data comprises the currency data and the currency create signature, the currency data comprising: a value of the amount of new digital currency; and currency key data based at least in part on a currency public key, wherein the currency public key corresponds to the amount of digital currency.

Thus, the amount of digital currency will be identifiable by the digital currency key data. A currency secret key corresponding to the currency public key is derivable by the owner of the amount of digital currency, such that they may use the amount of digital currency (for example, transfer, or split, or join, etc, the amount of digital currency) at a later time. The method may further comprise generating the currency secret key corresponding to the currency public key.

By including the currency create signature, the currency data may be verified by other entities in a digital currency system (for example, by verifiers and/or user entities etc). This may improve the security of the digital currency system and of transactions in the system.

Preferably, the method further comprises: outputting the create data for provision to a verification entity to enable the verification entity to add the create data to the digital currency ledger. The verification entity may thus verify the currency create signature using at least a currency creator public key corresponding to the currency creator secret key and add the create data to the digital currency ledger only if verification is successful.

The method may further comprise: generating a new block comprising the create data; and adding the new block in the digital currency ledger. This may be performed by the verification entity, or by the entity that generated the create data (for example, where only one entity in a digital currency network is able to generate create data, such that it does not need to be verified by a separate entity before it is added to the digital currency ledger).

The method may further comprise: generating the currency public key. A corresponding currency secret key may also be generated.

Preferably, the currency key data comprises a hash of the currency public key.

Preferably, a currency creator public key corresponding to the currency creator private key is obtainable by a verification entity (for example, from a key block chain and/or software stored in memory in the verification entity).

A currency creator pubic key corresponding to the currency creator private key may be obtainable by at least one entity (for example, a user entity) in a network of digital currency entities (for example, from a key block chain and/or software stored in memory in the entity).

The present disclosure also provides an electronic device for performing a create operation to create an amount of new digital currency, the electronic device comprising: a processor; and a memory storing a software program, wherein the software program, when executed by the processor, causes the processor to perform the method disclosed above.

The present disclosure also provides a software program configured to perform the method disclosed above, when executed on a processor of an electronic device.

In a further aspect of the present disclosure, there is provided a method for verifying create data for creating digital currency, the create data comprising currency data and a currency create signature, the method comprising a verification entity: obtaining a currency creator public key; and performing a verification process on the currency create signature using at least the currency data and currency creator public key. Thus, a trusted verified may check that the create data has been generated by an authorised entity before it is added to the digital currency ledger, thereby improving security of the system and of transactions.

The currency creator public key may be obtained from a key block chain or from memory in the verification entity.

Preferably, the method further comprises: if the outcome of the verification process is a positive verification of the currency signature, adding the create data to a digital currency ledger; and if the outcome of the verification process is a negative verification of the currency signature, discarding the create data.

Adding the create data to the digital currency ledger may comprise: generating a verifier signature using at least a verifier secret key; generating verification data comprising an identifier of the verification entity and the verifier signature; generating a new block comprising the create data and the verification data; and adding the new block in the digital currency ledger.

The verification data may be included in any suitable part of the new block, for example in the block header and/or as at least part of the operation data of the new block.

By including the verification data in the new block, other entities reviewing the block may check the verifier signature using at least a verifier public key corresponding to the verifier secret key, and thus be assured that the data in the new block has been verified and approved by a trusted verifier. This may reduce time and data burdens on entities within the digital currency system, and therefore improve efficiency, because it will not be necessary for other entities to check all of the data in the block (which would potentially require going through a large amount of historical data in the digital currency ledger). Consequently, other entities in the digital currency system may need to download and review less data in order to be satisfied that create data in the block is valid.

Generating the verifier signature may comprise cryptographically signing at least the identifier of the verification entity using the verifier secret key.

Preferably, a verifier public key corresponding to the verifier private key is obtainable (for example, from a key block chain, or from memory in the entity) by at least one entity in a network of digital currency entities.

The present disclosure also provides a verification entity comprising: a processor; and a memory storing a software program, wherein the software program, when executed by the processor, causes the processor to perform the method disclosed above.

The present disclosure also provides a software program configured to perform the method disclosed above, when executed on a processor of a verification entity.

The present disclosure also provides a system comprising: the above disclosed electronic device for performing a create operation to create an amount of new digital currency; and the above disclosed verification entity, wherein the verification entity is configured to verify the create data.

In a further aspect of the present disclosure, there is provided a method for creating an amount of digital currency, the method comprising: generating a currency create signature by cryptographically signing currency data using at least a currency creator secret key;

generating verifiable create data suitable for addition to a digital currency ledger (for example, a block chain), wherein the create data comprises the currency data and the currency create signature, the currency data comprising: a value of the amount of new digital currency; and currency key data based at least in part on a currency public key, wherein the currency public key corresponds to the amount of digital currency; obtaining a currency creator public key; performing a verification process on the currency create signature using at least the currency data and currency creator public key; and if the verification process is successfully passed, adding the create data to a digital currency ledger.

There is also provided a system configured to perform the above disclosed method.

In a further aspect of the present disclosure, there is provided a method for destroying an amount of digital currency, the method comprising: generating a currency destroy signature by cryptographically signing currency data using at least a currency destroyer secret key; and generating verifiable destroy data suitable for addition to a digital currency ledger (for example, a block chain), wherein the destroy data comprises the currency data and the currency destroy signature, and wherein the currency data comprises: currency key data based at least in part on a currency public key associated with the amount of digital currency.

Thus, it is possible to destroy amounts of digital currency in the digital currency system, for example when it is identified that those amounts relate to fraudulent activity, or when destroying the amount would significantly move forward the oldest active block in the digital currency ledger (for example, it would enable a large number of blocks in the digital currency ledger to be discarded for no longer having any unspent/active amounts of the digital currency).

By including the currency destroy signature, the destroy data may be verified by other entities in the digital currency system (for example, by verifiers and/or user entities etc). This may improve the security of the digital currency system and of transactions in the system.

Preferably, the method further comprises: outputting the destroy data for provision to a verification entity to enable the verification entity to add the destroy data to the digital currency ledger.

The method may further comprise: generating a new block comprising the destroy data; and adding the new block in the digital currency ledger. This may be performed by the verification entity, or by the entity that generated the destroy data (for example, where only one entity in a digital currency network is able to generate destroy data, such that it does not need to be verified by a separate entity before it is added to the digital currency ledger).

The method may further comprise: recording a value of the amount of digital currency and the currency key data. This may enable a new amount to the same value to be created at a later date if necessary (for example, where an amount has been destroyed in order to ‘archive’ blocks in the digital currency ledger).

The currency key data may comprise a hash of the currency public key.

Preferably, a currency destroyer public key corresponding to the currency destroyer secret key is obtainable by at least one entity (for example, a verification entity and/or a user entity) in a network of digital currency entities (for example, from a key block chain and/or software stored in memory in the entity).

The currency destroyer pubic key may be obtainable from a public key block chain or from memory in the at least one entity.

The present disclosure also provides an electronic device for performing a create operation to create an amount of new digital currency, the electronic device comprising: a processor; and a memory storing a software program, wherein the software program, when executed by the processor, causes the processor to perform the above disclosed method.

The present disclosure also provides a software program configured to perform the above disclosed method, when executed on a processor of an electronic device.

In a further aspect of the present disclosure, there is also provided a method for verifying destroy data for destroying an amount of digital currency, the destroy data comprising currency data and a currency destroy signature, the method comprising a verification entity: obtaining a currency destroyer public key; and performing a verification process on the currency destroy signature using at least the currency data and currency destroyer public key. Thus, a trusted verified may check that the destroy data has been generated by an authorised entity before it is added to the digital currency ledger, thereby improving security of the system and of transactions.

Preferably, the currency destroyer public key is obtained from a key block chain or from memory in the verification entity.

The method may further comprise: if the outcome of the verification process is a positive verification of the currency destroy signature, adding the destroy data to a digital currency ledger; and if the outcome of the verification process is a negative verification of the currency destroy signature, discarding the destroy data.

Adding the destroy data to the digital currency ledger may further comprise: generating a verifier signature using at least a verifier private key; generating verification data comprising an identifier of the verification entity and the verifier signature; generating a new block comprising the destroy data and the verification data; and adding the new block to the digital currency ledger.

The verification data may be included in any suitable part of the new block, for example in the block header and/or as at least part of the operation data of the new block.

By including the verification data in the new block, other entities reviewing the block may check the verifier signature using at least a verifier public key corresponding to the verifier secret key, and thus be assured that the data in the new block has been verified and approved by a trusted verifier. This may reduce time and data burdens on entities within the digital currency system, and therefore improve efficiency, because it will not be necessary for other entities to check all of the data in the block (which would potentially require going through a large amount of historical data in the digital currency ledger). Consequently, other entities in the digital currency system may need to download and review less data in order to be satisfied that destroy data in the block is valid.

Generating the verifier signature may comprise cryptographically signing at least the identifier of the verification entity using the verifier private key.

Preferably, a verifier public key corresponding to the verifier private key is obtainable by at least one entity in a network of digital currency entities.

The present disclosure also provides a verification entity comprising: a processor; and a memory storing a software program, wherein the software program, when executed by the processor, causes the processor to perform the method disclosed above.

The present disclosure also provides a software program configured to perform the method disclosed above, when executed on a processor of a verification entity.

The present disclosure also provides a system comprising: the above disclosed electronic device for performing a destroy operation to destroy an amount of digital currency; and the above disclosed verification entity, wherein the verification entity is configured to verify the destroy data.

In a further aspect of the present disclosure, there is also provided a method for destroying an amount of digital currency, the method comprising: generating a currency destroy signature by cryptographically signing currency data using at least a currency destroyer secret key; generating verifiable destroy data suitable for addition to a digital currency ledger (for example, a block chain), wherein the destroy data comprises the currency data and the currency destroy signature, and wherein the currency data comprises: currency key data based at least in part on a currency public key associated with the amount of digital currency; obtaining a currency destroyer public key; performing a verification process on the currency destroy signature using at least the currency data and currency destroyer public key; and if the verification process is successfully passed, adding the destroy data to a digital currency ledger.

There is also provided a system configured to perform the above disclosed method.

In a further aspect of the present disclosure, there is provided a method for verifying digital currency operation data comprising currency data and a signature based at least in part on the currency data, the method comprising a verification entity performing the steps of: performing a verification process on the currency data using at least the signature; and if the outcome of the verification process is a positive verification: generating verification data comprising a verifier signature; generating a new block comprising the digital currency operation data and the verifier data; and adding the new block to a digital currency ledger.

The currency data may comprise input data and/or output data identifying at least one input amount of digital currency and/or at least one output amount of digital currency. The verification process may comprise verifying the currency data using the signature and a public key associated with the currency data (for example, a public amount key included in the currency data and/or a creator public key and/or a destroyer public key).

The verification data may be included in any suitable part of the new block, for example in the block header and/or as at least part of the operation data of the new block.

By including the verification data in the new block, other entities reviewing the block may check the verifier signature using at least a verifier public key corresponding to the verifier secret key, and thus be assured that the data in the new block has been verified and approved by a trusted verifier. This may reduce time and data burdens on entities within the digital currency system, and therefore improve efficiency, because it will not be necessary for other entities to check all of the data in the block (which would potentially require going through a large amount of historical data in the digital currency ledger). Consequently, other entities in the digital currency system may need to download and review less data in order to be satisfied that each set of operation data in the block is valid.

When the digital currency operation data is create data or destroy data, and when the public key associated with the digital currency operation is a public key associated with the entity that generated the digital currency operation data, preferably the method further comprises: obtaining the public key, and the verification process comprises: decrypting the signature using at least the public key; and comparing the decrypted signature with the digital currency operation data.

The public key may be obtained from a key block chain or from memory in the verification entity.

The digital currency ledger may comprise at least one historic block, each historic block comprising historic digital currency operation data identifying at least one output amount of digital currency, and the method may further comprise: setting in the new block an oldest active block identifier, wherein the oldest active block identifier identifies the oldest historic block that has historic digital currency operation data identifying at least one output amount of digital currency that is not identified in the digital currency operation data in any subsequent block in the digital currency ledger.

All blocks earlier than the identified oldest active block will include digital currency operation data relating to inactive amounts of digital currency (i.e., amounts of digital currency that have been used or spent by virtue of being identified in the digital currency operation data of a subsequent block in the digital currency ledger). Thus, only the digital currency ledger as far back as the oldest active block relates to active amounts of digital currency. Consequently, entities in the digital currency network need only store the digital currency ledger as far back as the block identified by the oldest active block identifier, thereby reducing data storage requirements. Furthermore, when a new entity joins the digital currency network, they need only download the digital currency ledger as far back as the block identified by the oldest active block identifier, thereby reducing data download burdens and improving ease and efficiency of joining the digital currency network.

The digital currency ledger may comprise at least one historic block, each historic block comprising historic digital currency operation data, and the method may further comprise: copying the historic digital currency operation data of at least one historic block into the new block. Where the historic block is the oldest active block in the digital currency ledger, by copying the historic digital currency operation data in this way (‘archiving’ the historic digital currency operation data), the historic block may be made inactive, such that the size of the active part of the digital currency ledger may be reduced. The data storage and data download burdens may thereby be even further reduced.

The digital currency ledger may comprises at least one historic block, each historic block comprising historic digital currency operation data, and the method may further comprise: destroying the amount of digital currency identified by at least one set of historic digital currency operation data of at least one historic block in the digital currency ledger. Where the historic block is the oldest active block in the digital currency ledger, by destroying the amount of digital currency operation data in this way (‘archiving’ the amount digital currency), the historic block may be made inactive, such that the size of the active part of the digital currency ledger may be reduced. The data storage and data download burdens may thereby be even further reduced.

In a further aspect of the present disclosure, there is provided a method for maintaining a digital currency ledger, the digital currency ledger comprising at least one historic block, each historic block comprising historic digital currency operation data identifying at least one output amount of digital currency, the method further comprising: determining the oldest active block, wherein the oldest active block is the historic block that has historic digital currency operation data identifying at least one output amount of digital currency that is not identified in the digital currency operation data in any subsequent block in the digital currency ledger; generating a new block comprising an oldest active block identifier, wherein the oldest active block identifies the determined oldest active block; and adding the new block to the digital currency ledger.

All blocks earlier than the identified oldest active block will include digital currency operation data relating to inactive amounts of digital currency (i.e., amounts of digital currency that have been used or spent by virtue of being identified in the digital currency operation data of a subsequent block in the digital currency ledger). Thus, only the digital currency ledger as far back as the oldest active block relates to active amounts of digital currency. Consequently, entities in the digital currency network need only store the digital currency ledger as far back as the block identified by the oldest active block identifier, thereby reducing data storage requirements. Furthermore, when a new entity joins the digital currency network, they need only download the digital currency ledger as far back as the block identified by the oldest active block identifier, thereby reducing data download burdens and improving ease and efficiency of joining the digital currency network.

The method may further comprise: copying the historic digital currency operation data of the determined oldest active block into the new block. By copying the historic digital currency operation data in this way (‘archiving’ the historic digital currency operation data), the historic block may be made inactive, such that the size of the active part of the digital currency ledger may be reduced. The data storage and data download burdens may thereby be even further reduced.

The method may further comprise: destroying at least one amount of digital currency identified in the historic digital currency operation data of the determined oldest active block. By destroying the amount of digital currency operation data in this way (‘archiving’ the amount digital currency), the historic block may be made inactive, such that the size of the active part of the digital currency ledger may be reduced. The data storage and data download burdens may thereby be even further reduced.

In a further aspect of the present disclosure, there is provided a method for maintaining a digital currency ledger, the digital currency ledger comprising at least one historic block, each historic block comprising historic digital currency operation data identifying at least one output amount of digital currency, the method further comprising: generating a new block comprising a copy of historic digital currency operation data of at least one historic block; and adding the new block to the digital currency ledger. By copying the historic digital currency operation data in this way (‘archiving’ the historic digital currency operation data), the historic block may be made inactive, such that the size of the active part of the digital currency ledger may be reduced. The data storage and data download burdens may thereby be even further reduced. Entities in the digital currency network may identify the oldest active block either using an oldest active block identifier in the most recent block in the digital currency ledger, or by reviewing and analysing the digital currency ledger for themselves.

Preferably, the new block comprises an oldest active block identifier, the method further comprising: determining the oldest active block, wherein the oldest active block is the historic block that has historic digital currency operation data identifying at least one output amount of digital currency that is not identified in the digital currency operation data in any subsequent block in the digital currency ledger; and setting the identifier of the oldest active block to identify the determined oldest active block.

The present disclosure also provides an electronic device comprising: a processor; and a memory storing a software program, wherein the software program, when executed by the processor, causes the processor to perform any of the methods disclosed above.

The present disclosure also provides a software program configured to perform any of the methods disclosed above, when executed on a processor of an electronic device.

In a further aspect of the present disclosure, there is also provided a method for maintaining a digital currency ledger, the digital currency ledger comprising at least one block of digital currency operation data, wherein the most recent of the at least one block comprises an identifier of the oldest active block, the method comprising: communicating at least part of the digital currency ledger to a network of digital currency entities, wherein the at least part of the digital currency ledger comprises the block identified by the identifier of the oldest active block and each subsequent block. Thus, only the active part of the digital currency ledger may be provided to any entities wishing to obtain the digital currency ledger, thereby reducing data storage and data download burdens and improving efficiency.

Communicating at least part of the digital currency ledger to the network of digital currency entities may comprise storing the at least part of the digital currency ledger in a location accessible to the network of digital currency entities.

The present disclosure also provides an electronic device comprising: a processor; and a memory storing a software program, wherein the software program, when executed by the processor, causes the processor to perform the method disclosed above.

The present disclosure also provides a software program configured to perform the method disclosed above, when executed on a processor of an electronic device.

In a further aspect of the present disclosure, there is also provided a method for obtaining a digital currency ledger, the digital currency ledger comprising at least one block of digital currency operation data, wherein the most recent of the at least one block comprises an identifier of the oldest active block, the method comprising: obtaining at least part of the digital currency ledger from a digital currency entity in a network of digital currency entities, wherein the at least part of the digital currency ledger comprises the block identified by the identifier of the oldest active block and each subsequent block. Thus, any entities wishing to obtain the digital currency ledger can obtain only the active part of the digital currency ledger, thereby reducing data storage and data download burdens and improving efficiency.

Obtaining at least part of the digital currency ledger from a digital currency entity in a network of digital currency entities may comprise: obtaining the most recent block in the digital currency ledger; identifying the oldest active block using at least the identifier of the oldest active block; and obtaining the oldest active block and all subsequent blocks.

The present disclosure also provides an electronic device comprising: a processor; and a memory storing a software program, wherein the software program, when executed by the processor, causes the processor to perform the method disclosed above.

The present disclosure also provides a software program configured to perform the method disclosed above, when executed on a processor of an electronic device.

In a further aspect of the present disclosure, there is provided a method for transferring digital currency from a first entity to a second entity, the method comprising the first entity: obtaining (for example, by receiving it from the first entity, or by looking it up in memory in the first entity, or by looking it up in a publically accessible memory location in a network of digital currency entities) wallet public key data associated with the second entity; generating, using at least the wallet public key data, a currency public key for the amount of digital currency to be transferred to the second entity; obtaining (for example, receiving or generating) a recipient identifier; and generating transfer data comprising at least the currency public key data, a value for the amount of digital currency to be transferred to the second entity and the recipient identifier. By including the recipient identifier in the transfer data, the recipient of the transfer may more quickly identify that the transfer data may be relevant to them, thereby reducing the time it takes for a recipient to find their transfer data in the digital currency ledger. It may also reduce the data processing required of the recipient where the digital currency system is configured such that the recipient derives the currency secret key at least in part from the currency public key data, since they can identify the correct transfer data in the digital currency ledger with more accuracy.

Obtaining the recipient identifier may comprise: generating the recipient identifier based at least in part on the wallet public key data. By generating the recipient identifier in this way, anonymity of the recipient may be achieved, whilst still keeping the number of sets of transfer data that a recipient may consider to be relevant to them to a minimum.

Preferably, the recipient identifier is generated by truncating the wallet public key data.

Obtaining the recipient identifier may comprise: receiving the recipient identifier from the second entity. By obtaining the recipient identifier in this way, the second entity (for example, the recipient) may set the recipient identifier to a unique, but anonymous, value, such that transfer data relevant to them may be identified uniquely, without jeopardising anonymity.

The method may further comprise: outputting the transfer data for provision to a verification entity to enable the verification entity to add the transfer data to a digital currency ledger.

The currency public key data may comprise at least one of the currency public key and/or a currency public key hash.

The wallet public key data may comprise at least one of a wallet public key and/or a wallet public key hash.

The present disclosure also provides an electronic device comprising: a processor; and a memory storing a software program, wherein the software program, when executed by the processor, causes the processor to perform the method disclosed above.

The present disclosure also provides a software program configured to perform the method disclosed above, when executed on a processor of an electronic device.

The present disclosure also provides a system comprising an electronic device as disclosed above and a verification entity configured to verify the transfer data.

In a further aspect of the present disclosure, there is provided a method for transferring digital currency from a first entity to a second entity, the method comprising: obtaining (for example, by generating, or retrieving from memory) a recipient identifier (which may optionally be based at least in part on wallet public key data); identifying in a digital currency ledger a set of transfer data that comprises the recipient identifier, wherein the transfer data also comprises currency public key data; and generating a currency secret key using at least: the currency public key data; and wallet secret key data corresponding to the wallet public key data.

Obtaining the recipient identifier may comprise generating the recipient identifier based at least in part on wallet public key data.

The wallet secret key data may comprise at least one of the wallet secret key and/or a hash of the wallet secret key.

The currency public key data may comprise at least one of the currency public key and/or a hash of the currency public key.

The present disclosure also provides an electronic device comprising: a processor; and a memory storing a software program, wherein the software program, when executed by the processor, causes the processor to perform the method disclosed above.

The present disclosure also provides a software program configured to perform the method disclosed above, when executed on a processor of an electronic device.

In a further aspect of the present disclosure there is provided a method for transferring digital currency from a first entity to a second entity, the method comprising the first entity: obtaining wallet public key data associated with the second entity; generating, using at least the wallet public key data, a currency public key for the amount of digital currency to be transferred to the second entity; obtaining (for example, receiving or generating) a recipient identifier; and generating transfer data comprising at least the currency public key data, a value for the amount of digital currency to be transferred to the second entity and the recipient identifier; adding the transfer data to a digital currency ledger; and the second entity obtaining (for example, generating, or looking up in memory) a recipient identifier (which may optionally be based at least in part on their wallet public key data); identifying in a digital currency ledger a set of transfer data that comprises the recipient identifier, wherein the transfer data also comprises currency public key data; and generating a currency secret key using at least: the currency public key data; and wallet secret key data corresponding to the wallet public key data.

There is also provided a system comprising a first entity, a second entity and a verification entity configured to perform the method disclosed above.

In a further aspect of present disclosure, there is provided a method for maintaining a block chain for public keys, the method comprising: generating public key data, the key block data comprising: a public key corresponding to a private key belonging to an entity in a digital currency network; and an identifier of the entity in the digital currency network; generating a master signature by cryptographically signing the public key data using at least a secret master key; generating key block data comprising at least the public key data and the master signature; and adding the key block data and the master signature to the block chain. Thus, public keys required for verifying operation data may be obtained by any entity in a digital currency network from the block chain. The block chain may be, for example, a key block chain, or the digital currency ledger. By including the master signature, other entities reviewing the block chain may check the master signature using at least a public master key, and thus be assured that the public key has been issued an authorised entity (for example, the primary authority). Thus, security of the public keys, and therefore the digital currency system, may be increased.

The public key data may comprise an expiry date for the public key.

The public key data may comprise an indicator for indicating the validity of the public key, the method further comprising: setting the indicator to indicate that the public key is invalid. In this way, public keys may be revoked. The indicator may be the expiry date, which may be set to a date in the past to indicate that the public key is invalid.

The key block data may further comprise at least one of: a block number; a time stamp; and/or a hash of the previous block in the block chain.

There is also provided an electronic device comprising: a processor; and a memory storing a software program, wherein the software program, when executed by the processor, causes the processor to perform the method disclosed above.

There is also provided a software program configured to perform the method disclosed above, when executed on a processor of an electronic device.

In a further aspect of the present disclosure, there is provided a method for obtaining a public key associated with an entity in a digital currency system, the method comprising: obtaining a master public key; obtaining key block data from a key block chain, the key block data comprising at least public key data and the master signature; and performing a verification operation on the public key data using at least the master signature and the master public key, wherein the public key data comprises an identifier of the entity in the digital currency system and the public key.

The public key data may comprise an indicator of the validity of the public key, and the verification operation may comprise checking the indicator of the validity of the public key.

There is also provided an electronic device comprising: a processor; and a memory storing a software program, wherein the software program, when executed by the processor, causes the processor to perform the method disclosed above.

There is also provided a software program configured to perform the method disclosed above, when executed on a processor of an electronic device.

In a further aspect of the present disclosure, there is provided a method for transferring digital currency from a first entity to a second entity, the method comprising the first entity: obtaining a group secret key (for example, from a primary authority in response in returning for providing a wallet public key and corresponding tracking key to the primary authority); generating currency data comprising currency public key data and a value for the amount of digital currency to be transferred to the second entity; generating a transfer signature by cryptographically signing at least part of the currency data using a currency secret key known to the first entity (for example, the currency secret key corresponding to an input amount of digital currency to the transfer); generating a group signature by cryptographically signing at least part of the currency data using the group secret key; and generating transfer data comprising the currency data, the transfer signature and the group signature for addition to a digital currency ledger. In this way, a verifier of the transfer data can use the group signature to verify that the first entity (which generated the currency data) is part of the authorised group (for example, by virtue of providing their wallet public key and corresponding tracking key to the primary authority).

Preferably, the currency public key data comprises a currency public key associated with an input amount of digital currency to the transfer and a currency public key associated with an output amount of digital currency to the transfer.

Preferably, the currency secret key corresponds with the currency public key associated with the input amount of digital currency.

The method may further comprise generating a wallet public key and a corresponding tracking key; and providing the wallet public key and the corresponding tracking key to a primary authority.

There is also provided an electronic device comprising: a processor; and a memory storing a software program, wherein the software program, when executed by the processor, causes the processor to perform the method disclosed above.

There is also provided a software program configured to perform the method disclosed above, when executed on a processor of an electronic device.

In a further aspect of the present disclosure, there is provided a method of administering a digital currency system, the method comprising: receiving a wallet public key and a corresponding tracking key from a user entity; and providing a group secret key to the user entity, using which the user entity may generate group signatures for inclusion as part of digital currency operation data. In this way, the user entity may receive the group secret key for generating group signatures, which may be required in order to have digital currency operation data verified in the future, only after it has provided its wallet public key and corresponding tracking key to the primary authority.

The method may further comprise recording the wallet public key and corresponding tracking key with an association to user data corresponding to the user entity. The user data may comprise at least one of a name and/or address for the user, a telephone number, an email address, a bank account number, a bank sort code, etc.

There is also provided an electronic device comprising: a processor; and a memory storing a software program, wherein the software program, when executed by the processor, causes the processor to perform the method disclosed above.

There is also provided a software program configured to perform the method disclosed above, when executed on a processor of an electronic device.

There is also provided a system comprising a first electronic device configured to perform the method of administering the digital currency system disclosed above and a second electronic device configured to a method for transferring digital currency from a first entity to a second entity disclosed above.

In a further aspect of the present disclosure there is provided a method of administering a digital currency ledger comprising: obtaining a wallet public key and a corresponding tracking key; using the wallet public key and the tracking key to identify in the digital currency ledger at least one amount of digital currency transacted to and/or from a digital currency wallet associated with the wallet public key; and maintaining a record of the amounts of digital currency transacted to and/or from the digital currency wallet associated with the wallet public key.

There is also provided an electronic device comprising: a processor; and a memory storing a software program, wherein the software program, when executed by the processor, causes the processor to perform the method disclosed above.

There is also provided a software program configured to perform the method disclosed above, when executed on a processor of an electronic device.

The methods described above may be implemented as a computer program comprising program instructions to operate a computer (an electronic device). The computer program may be stored on a computer-readable medium.

The computer system may include a processor such as a central processing unit (CPU). The processor may execute logic in the form of a software program. The computer system may include a memory including volatile and non-volatile storage medium. A computer-readable medium may be included to store the logic or program instructions. The different parts of the system may be connected using a network (e.g. wireless networks and wired networks). The computer system may include one or more interfaces. The computer system may contain a suitable operating system such as UNIX, Windows® or Linux, for example.

It should be noted that any feature described above may be used with any particular aspect or embodiment of the invention.

### DRAWINGS

Aspects of the present disclosure are described, by way of example only, with reference to the following drawings, in which:

FIG. 1 shows a representation of a prior art transaction;

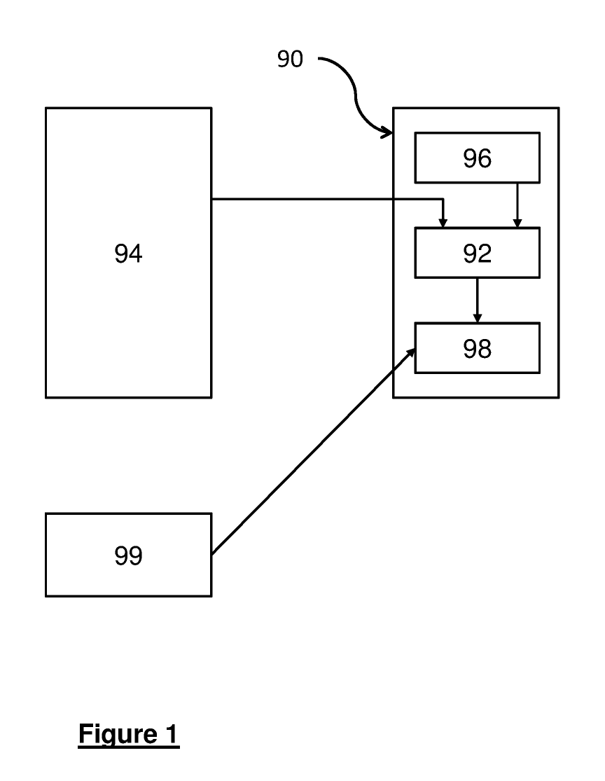

FIG. 2 shows a schematic representation of a network of digital currency entities in accordance with the present disclosure;

FIG. 3 shows a schematic representation of a new block to be broadcast to the network of digital currency entities of FIG. 2;

FIG. 4 shows an example use of digital currencies in the network of digital currency entities of FIG. 2;

FIG. 5 shows a further example use of digital currency in the network of digital currency entities of FIG. 2;

FIG. 6 shows a further example use of digital currency in the network of digital currency entities of FIG. 2;

FIG. 7 shows a further example use of digital currency in the network of digital currency entities of FIG. 2;

FIG. 8 shows an example schematic representation of operation data in a digital currency ledger used by the network of digital currency entities of FIG. 2;

FIG. 9 shows an example representation of a digital currency ledger used by the network of digital currency entities of FIG. 2; and

FIG. 10 shows a further example representation of a digital currency ledger and key block chain used by the network of digital currency entities of FIG. 2.

### DETAILED DESCRIPTION

The present disclosure provides a digital currency system wherein amounts of digital currency may be created, destroyed, split, joined or transferred by adding suitable operation data to a digital currency ledger (for example, a block chain). In the present disclosure, an ‘operation’ may be considered analogous to a ‘transaction’ in other digital currency system (for example, bitcoin), but the digital currency subject to the operation will not necessarily change ownership. Thus, an operation is a digital currency action. An operation may be performed by an entity by generating operation data that is verifiable and suitable for addition to a digital currency ledger (for example, a block chain).

As will be appreciated from the below description, some operations may be performed only by authorised entities (such as the create and destroy operations) and other operations may be performed by any entity that holds or owns the amount of digital currency on which the operation is to be performed (for example split, join and transfer operations). Operation data may be provided to at least one trusted verification entity, which may verify that the operation data is valid. If the operation data is verified as valid, the trusted verification entity may then add to the digital currency ledger (the block chain) a new block comprising the operation data, for example by broadcasting the new block to a network of digital currency entities. In this way, the digital currency ledger, which is freely available to all entities in the network of digital currency entities, maintains a record of active/valid (for example, unspent) amounts of digital currency.

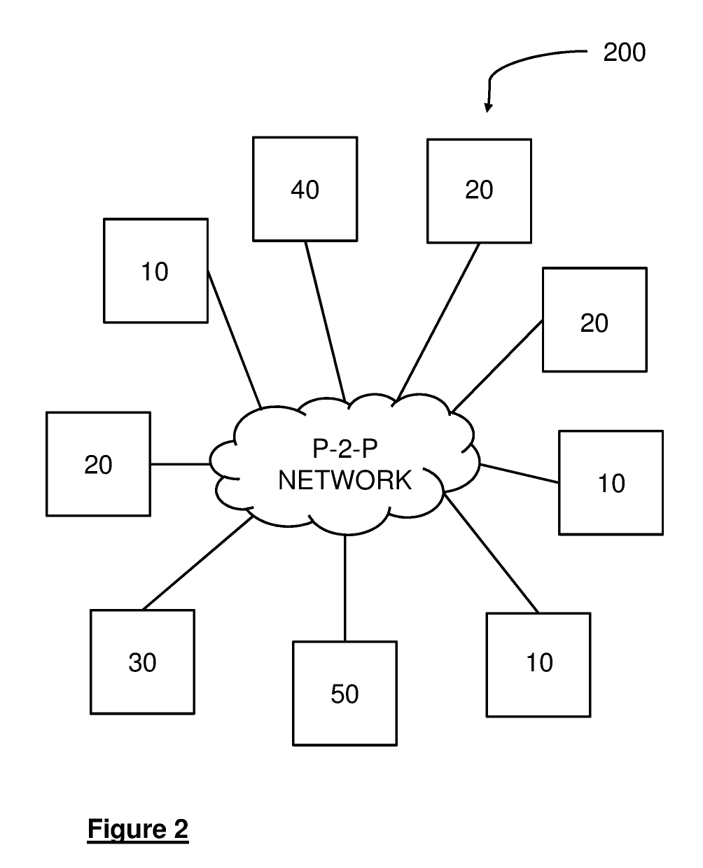

FIG. 2 shows a highly schematic representation of a network 200 of digital currency entities in accordance with the present disclosure. The network 200 comprises user entities 10, verification entities 20, a currency issuer entity 30, a currency destroyer entity 40 and a primary authority entity 50, all of which interface using a Peer-to-Peer (P2P) Network.

Each of the entities in the network 200 may operate on the network using any suitable type of electronic device configured to store and execute digital currency software. For example, each entity may be a desktop or laptop computer, or a mobile device such as a smart phone or tablet computer, or a network server, etc. Each entity may comprise memory on which digital currency software can be stored and at least one processor on which the software may be executed. The digital currency software may be provided by the primary authority 50 to entities wishing to join the network 200. The digital currency software provided to each different type of entity may be different (for example, there may be user software for user entities 10, verification software for verification entities 20, etc). Each entity may comprise at least one user input means, for example a keyboard, microphone, touchscreen, tracker device such as a mouse, etc, using which an operator may input commands and/or instructions to the electronic device. Furthermore, each entity may comprise at least one user output means, for example a display device for presenting information in a visual and/or tactile form (for example, a display screen using any form of display technology, such LED, OLED, TFT, LCD, Plasma, CRT, etc), and/or speakers for outputting information in an aural form, etc. Each user entities 10 may further comprise at least one imaging means, for example at least one camera and/or optical scanner, using which optical codes, such as QR codes, may be scanned.

All of the entities in the network 10 are interconnected via the P2P Network such that data may be communicated from any entity in the network 200 to any other one or more (or all) entities in the network 200. The entities may be interconnected and transfer data between each other in any standard way. Communication in the network 200 may utilise any suitable communications architecture and protocols and each entity may utilise the same or different types of data connection. For example, each of the entities in the network 200 may connect to the P2P network using any suitable communication technology, such as Ethernet, WiFi, WiMAX, GPRS, EDGE, UMTS, LTE, etc. If an entity (for example, a verification entity 20) broadcasts data (for example, a new block) to the network 200, the data is effectively made available to all entities in the network 200. The data may be communicated from an entity (such as a user entity 10) to all of the entities in the network 200 and/or to a central location that is accessible to all entities in the network 200. Alternatively, particular types of data may be communicated to only certain types of entity, for example, some operation data may be communicated from a user entity 10 to only verification entities 20 and optionally also the primary authority 50.

Each user entity 10 comprises their own, unique wallet public key (pw), which is the public address for their digital currency. Each user entity 10 may distribute their wallet public key (pw) as they wish (for example, they may broadcast it to the entire network 200, or provide it to any entity with which they wish to transact, etc). Each user entity 10 will also comprise a wallet secret key (sw) corresponding to the wallet public key (pw). Thus, the wallet public key (pw) and the wallet secret key (sw) form a public-private key pair. The user entity 10 will keep the wallet secret key (sw) secret and may store it in any suitable way, for example using a hardware device, such as a smart card (for example, a SIM card) or in software, or written on paper, etc.

Each user entity 10 may be provided with their wallet public key (pw) and wallet secret key (sw) at any suitable time, for example by the primary authority 50 when digital currency software is provisioned to the user entity 10, or they may generate their wallet public key (pw) and the wallet secret key (sw). The wallet public key (pw) and wallet secret key (sw) may be generated in accordance with any standard cryptographic public-private key pair cryptosystem (such as Elliptic Curve Cryptography, RSA, etc).

Each amount of digital currency that a user entity 10 owns has a corresponding currency public key (p) and a currency secret key (s). The currency public key (p) (and/or a hash of the currency public key) is visible as an input and/or output in operation data on the digital currency ledger and publically identifies the amount of digital currency. The currency secret key (s) is known only to the user entity 10 that owns the amount of digital currency. Thus, possession of a currency secret key (s) implies ownership of the corresponding amount of digital currency. Again, the user entity 10 may store the currency secret key(s) corresponding to each amount of digital currency that they own in any suitable way.

### Operations

Operation data comprises at least one of input data and output data (which together may be referred to as currency data). Operation data also comprises a signature generated by the generator of the operation data, wherein the signature is generated by cryptographically signing the currency data using a private key.

After an entity has generated operation data, it may be provided to at least one verification entity 20, for example by broadcasting it to the network 200, or communicating it only to the verification entities 20 in the network 200 (and optionally also the primary authority 50). The verification entity (or entities) may then verify that the operation data is valid. This is described in more detail in the ‘Verification of Operations’ section below.

Examples of the operations are set out below.

### Create Operation

| Field | | | |
|---|---|---|---|
| no. | Input | Output | Signature |
| 1. | | Currency public | New currency signature |
| | | key hash (p1h) | (cryptographic signature of |
| | | | the Output using currency |
| | | | issuer secret key (sb) |
| 2. | | Value (v1) | |

The CREATE operation is performed by a currency issuer 30 by generating operation data (referred to for this operation as create data). The currency issuer 30 is an entity that holds a currency issuer secret key (sb) and therefore has the authority to create amounts of digital currency. Other entities do not have the authority to perform the CREATE operation because they do not hold a currency issuer secret key.

As can be seen, the create data does not comprise any input data. This is because the CREATE operation is for the creation of an amount of new digital currency.

The Output data may be referred to as ‘currency data’ and comprises a currency public key hash (p1h) (Output Field 1.) and a Value (v1) (Output Field 2.). The currency public key hash (p1h) is a hash of a currency public key (p1). The currency public key (p1) may be hashed in any suitable way, using any suitable type of hashing function.

The currency public key (p1) is the public key associated with the amount of digital currency being created. It publically identifies the amount that is being created and will have a corresponding currency private, or secret, key (s1) that is known to the currency issuer 30. The currency secret key (s1) can be used subsequently to perform operations on the digital currency amount created by the CREATE operation (as will be seen later). The currency public key (p1) and the currency secret key (s1) may be generated using any standard public-private key pair generation technique.

Output Field 1. may be referred to as currency key data and in this example comprises the currency public key hash (p1h). However, it may additionally or alternatively comprise at least the currency public key (p1).

The value (v1) is the value of the amount of digital currency being created. For example, the value (v1) may be 1 currency unit, or 8 currency units, or 40 currency units, or 0.2 currency units, or 0.43 currency units, etc.

Optionally, the CREATE operation may be to create two or more new amounts of digital currency. Each new amount of digital currency will have a corresponding currency public key, currency public key hash and value. Each currency public key will be generated as explained above, such that the currency issuer will have corresponding currency secret keys for each new amount. The currency public key hash and value of each new amount of digital currency will be included in the Output data and the currency key data will therefore comprise the currency public key hashes of each new amount.

The currency issuer 30 generates the new currency signature (Signature Field 1.) by cryptographically signing the currency data (the Output data) using the currency issuer secret key (sb). A corresponding currency issuer public key (pb) is obtainable by verification entities 20, such that they are able to verify that the currency issuer signature was correctly created by a currency issuer using their currency issuer secret key (sb). The currency data may also comprise an identifier of the currency issuer 30, which the verification entities 20, and/or any other entities in the digital currency network 200, may use to look up the currency issuer public key (pb) corresponding to the particular currency issuer 30 who generated the create data. This is explained in more detail in the ‘Verification of Operations’ and ‘Key Block Chains’ sections below.

After performing the CREATE operation, the create data may be communicated to the verification entities 20 by the currency issuer 30, for example by broadcasting the create data to the network 200, or by communicating the create data just to the verification entities 20 directly, or by putting the create data in a location that is accessible to the verification entities 20. If the create data is verified as being valid, the currency issuer 30 will then hold, or own, the newly created amount of digital currency, by virtue of the fact that they have the currency secret key(s) (as will be seen later).

### Split Operation

| Field | | | |
|---|---|---|---|
| no. | Input | Output | Signature |
| 1. | Currency public | Currency public | Split signature |
| | key hash (p1h) | key hash (p2h) | (cryptographic signature of |
| | | | the Input and Output using |
| | | | the currency secret key (s1) |
| 2. | Currency public | Value (v2) | |
| | key (p1) | | |
| 3. | | Currency public | |
| | | key hash (p3h) | |
| 4. | | Value (v3) | |

The SPLIT operation is performed by the owner, or holder, of an amount of digital currency (i.e., the entity that has, or holds, the currency secret key (s1) for the amount of digital currency) by generating operation data (referred to for this operation as split data). The owner, or holder, may be a user entity 10 or a currency issuer entity 30. The operation is to split a single input amount of digital currency into at least two output amounts of digital currency. Thus, it may be useful where an entity owns an amount of digital currency that has a high value and they wish to split the amount into at least two amounts of digital currency, each with a smaller value.

The Input data and Output data may together be referred to as ‘currency data’. The Input data comprises the currency public key hash (p1h) (Input Field 1.) and the currency public key (p1) (Input Field 2.) corresponding to the amount of digital currency to be split.

The Output data comprises a currency public key hash (p2h) (Output Field 1.), Value (v2) (Output Field 2.), a currency public key hash (p3h) (Output Field 3.) and Value (v3) (Output Field 4.). The currency public key hash (p2h) is a hash of a currency public key (p2) and the currency public key hash (p3h) is a hash of a currency public key (p3). Each of the currency public keys p2 and p3 correspond to output amounts of digital currency. The values v2 and v3 are the values of each of the output amounts of digital currency. Values v2 and v3 will be set such that v1=v2+v3. If this is not the case, the verification entity 20 may deem the split data to be invalid (as explained in more detail in the ‘Verification of Operations’ section below).

The ownership of the input amount and the output amounts does not change. Preferably, the currency public key hash (p2h) and currency public key hash (p3h) are generated based on the wallet public key (pw) of the owner of the input amount in accordance with the key generation process described in detail in section 4 of the white paper ‘CryptoNote v 2.0’ by Nicholas van Saberhagen, published 17 Oct. 2013 (available at https://cryptonote.org/whitepaper.pdf) (in particular, in section 4.2.2 ‘Terminology’, section 4.3 ‘Unlinkable payments’ and section 4.5 ‘Standard CryptoNote transaction’). It will be appreciated that any suitable elliptic curve may be used. Thus, the corresponding currency secret key (s2) may be derived from the currency public key hash p2h and the wallet secret key (sw), and the corresponding currency secret key (s3) from the currency public key hash p3h and the wallet secret key (sw). It will be appreciated that whilst p2h and p3h are both based on the wallet public key (pw), they may still be different values by using different random numbers in the generation process for p2h and p3h.

In an alternative, since the entity performing the SPLIT operation will own the output amounts, they may simply generate public-private key pairs for each pair p2-s2 and p3-s3 according to any standard cryptographic technique. However, if this is done, the ‘tracking key’ (described in more detail below) may no longer be operable.

The currency public key (p2) may be hashed in any suitable way, using any suitable hashing function, to generate the currency public key hash (p2h). Likewise, the currency public key (p3) may be hashed in any suitable way, using any suitable hashing function, to generate the currency public key hash (p3h). Preferably, p2 is hashed in the same way, using the same hashing function, as p3, such that p2h and p3h are generated in analogous ways.

The split data also comprises a split signature (Signature Field 1.), generated by cryptographically signing the currency data using the currency secret key (s1). A verification entity 20 may thus use the currency public key (p1) to verify that the split data was signed by the currency secret key (s1) and therefore verify that the split data had been generated by the owner of the input amount (as explained in more detail in the ‘Verification of Operations’ section below).

In this example, the split data comprises only two output currency amounts, each represented by currency public key hash (p2h) and currency public key hash (p3h) respectively. However, it will be appreciated that the split data may comprise any number of output currency amounts (for example, three, or four, or seven, or 14, etc), each with a corresponding currency public key hash and value. The total value of all output amounts should equal the value of the input amount.

Furthermore, in this example, the split data comprises a single input currency amount, represented by the currency public key hash (p1h). However, it will be appreciated that the split data may comprise two or more input amounts, each with a corresponding currency public key hash and currency public key. This may be of use where an entity has multiple amounts of digital currency, the total value of which they wish to distribute differently across two or more output amounts.

Such an operation may be considered to be a JOIN & SPLIT operation. For example, an entity may have a first amount with a value of 10 units and a second amount with a value of 4 units and may wish to have three amounts of value 11 units, 2 units and 1 unit respectively. In this case, the operation data would have two input amounts (of value 10 units and 4 units respectively) and three output amounts (of value 11 units, 2 units and 1 unit respectively). The number of input amounts may be the same as, greater than, or less than, the number of output amounts, provided that the number of input amounts is at least two and the number of output amounts is at least two. It will be appreciated from the below description of a JOIN operation that the operation data may comprise a number of signatures corresponding to the number of input amounts. Again, the total value of all output amounts should equal the total value of all input amounts.

After generating the split data, they may be communicated to the verification entities 20. If the split data is verified as being valid, the entity that performed the SPLIT operation will also hold, or own, the newly created amounts of digital currency, by virtue of the fact that they have, or can derive, the corresponding currency secret keys.

### Join Operation

| Field | | | |
|---|---|---|---|
| no. | Input | Output | Signature |
| 1. | Currency public | Currency public | Join signature 1 |
| | key hash (p1h) | key hash (p3h) | (cryptographic signature of |
| | | | the Input and Output using |
| | | | the currency secret key |
| | | | (s1)) |
| 2. | Currency public | Value (v3) | Join signature 2 |
| | key (p1) | | (cryptographic signature of |
| | | | the Input and Output using |
| | | | the currency secret key |
| | | | (s2)) |
| 3. | Currency public | | |
| | key hash (p2h) | | |
| 4. | Currency public | | |
| | key (p2) | | |

The JOIN operation is performed by the owner, or holder, of two or more amounts of digital currency (i.e., the entity that has, or holds, the currency secret keys s1 and s2 for each of the input amounts of digital currency) by generating operation data (referred to for this operation as join data). The owner, or holder, may be a user entity 10 or a currency issuer entity 30. The operation is to combine input amounts of digital currency into a single output amount of digital currency. Thus, it may be useful where an entity owns two or more separate amounts of digital currency, but wishes to combine them into a single amount.

The Input data and Output data may together be referred to as ‘currency data’. The Input data comprises the currency public key hash (p1h) of the first input amount (Input Field 1.), the currency public key (p1) of the first input amount (Input Field 2.), the currency public key hash (p2h) of the second input amount (Input Field 3.) and the currency public key (p2) of the second input amount (Input Field 4.).

The Output data comprises a currency public key hash (p3h) (Output Field 1.) and a value (v3) (Output Field 2.). The currency public key hash (p3h) is a hash of a currency public key (p3) corresponding to the output amount of digital currency. The value v3 is the value of the output amount of digital currency. The value v3 will be set such that it equals the value of the input amounts (i.e., v1+v2=v3). If this is not the case, the verification entity 20 may deem the join data to be invalid (as explained in more detail in the ‘Verification of Operations’ section below).

The ownership of the input amounts and the output amount does not change. Preferably, the currency public key hash (p3h) is generated based on the wallet public key (pw) of the owner of the input amounts in accordance with the key generation process described in detail in section 4 of the white paper ‘CryptoNote v 2.0’ by Nicholas van Saberhagen, published 17 Oct. 2013 (available at https://cryptonote.org/whitepaper.pdf) (in particular, in section 4.2.2 ‘Terminology’, section 4.3 ‘Unlinkable payments’ and section 4.5 ‘Standard CryptoNote transaction’). It will be appreciated that any suitable elliptic curve may be used. Thus, the corresponding currency secret key (s3) may be derived from the currency public key hash (p3h) and the wallet secret key (sw).

In an alternative, since the entity performing the JOIN operation will own the output amount, they may simply generate public-private key pairs for each pair p2-s2 and p3-s3 according to any standard cryptographic technique. However, if this is done, the ‘tracking key’ (described in more detail below) may no longer be operable.

The currency public key (p3) may be hashed in any suitable way, using any suitable hashing function, to generate the currency public key hash (p3h).

The join signature 1 (Signature Field 1.) may be generated by cryptographically signing the currency data using the currency secret key (s1). The join signature 2 (Signature Field 2.) may be generated by cryptographically signing the currency data using the currency secret key (s2). A verification entity 20 may thus use the currency public keys p1 and p2 to verify that the currency data was signed by the currency secret keys s1 and s2 to create the join signatures and therefore verify that the join data is valid.

In this example, the join data comprises only two input amounts, each represented by currency public key hash (p1h) and currency public key hash (p2h) respectively. However, it will be appreciated that the join data may comprise more than two input amounts (for example, three, five, six, 12, etc), each with a corresponding currency public key hash and currency public key. The total value of all the input amounts of digital currency should equal the value of the output amount of digital currency.

Furthermore, it will be appreciated that the join data may comprise two or more output amounts of digital currency. Such an operation may be considered to be a JOIN & SPLIT operation, which is described in more detail above.

After generating the join data, they may be communicated to verification entities 20. If the split data are verified as being valid, the entity that performed the JOIN operation will also hold, or own, the newly created amount of digital currency, by virtue of the fact that they have, or can derive, the corresponding currency secret keys.

### Destroy Operation

| Field | | | |
|---|---|---|---|
| no. | Input | Output | Signature |
| 1. | Currency public | | Currency destroy signature |
| | key hash (p1h) | | (cryptographic signature of |
| | | | the Input using currency |
| | | | destroyer secret key (sd) |

The DESTROY operation is performed by a currency destroyer 40 by generating operation data (referred to for this operation as destroy data). A currency destroyer 40 is an entity that holds a currency destroyer secret key (sd) and therefore has the authority to destroy amounts of digital currency. Other entities do not have the authority to perform the DESTROY operation because they do not hold a currency destroyer secret key. Optionally, the currency destroyer may be the same entity as the currency issuer 30. Optionally, the currency destroyer secret key (sd) may be the same as the currency issuer secret key (sb), in which case the currency destroyer public key (pd) would also be the same as the currency issuer public key (pb).

As can be seen, the destroy data does not comprise Output data. This is because the DESTROY operation destroys the input amount of digital currency.

The Input data may be referred to as ‘currency data’ and comprises the currency public key hash (p1h) (Input Field 1.) of the amount of digital currency to be destroyed.

Optionally, the DESTROY operation may be to destroy two or more amounts of digital currency. Each amount to be destroyed will have a corresponding currency public key hash included in the Input data.

The currency destroyer 40 generates the currency destroy signature (Signature Field 1.) by cryptographically signing the currency data using the currency destroyer secret key (sd). A corresponding currency destroyer public key (pd) is obtainable by verification entities (analogously to the currency creator public key (pb)), such that they are able to verify that the currency destroyer signature was correctly created by a currency destroyer 40 using their currency destroyer secret key (sd). The currency data may also comprise an identifier of the currency destroyer 40, which the verification entities 20, and/or any other entities in the digital currency network 200, may use to look up the currency destroyer public key (pd) corresponding to the particular currency destroyer 40 who generated the destroyer data. This is explained in more detail in the ‘Verification of Operations’ and ‘Key Block Chains’ sections below.

It can be seen that because the currency destroy signature is generated using the currency destroyer secret key (sd), and not the currency secret key (s1) corresponding to the amount to be destroyed, the currency destroyer 40 does not need to own the amount to be destroyed (i.e., they do not need to know 51). Thus, a currency destroyer 40 may destroy any digital currency amount. This may have a number of benefits, for example when it is identified that an owner of an amount obtained the amount by fraudulent or illegal means, or where there is a desire to reduce the total value of digital currency in circulation, or when it is helpful to archive old amounts of digital currency (as explained later) or where the owner of an amount can prove that they own an amount but have lost the corresponding currency secret key, in which case a currency destroyer 40 may destroy the amount and a currency issuer 30 may create a new amount and transfer ownership of the new amount to the owner.

After generating the destroy data, it may be communicated to the verification entities 20 by the currency destroyer 40. If the destroy data is verified as being a valid, the destroyed amount no longer exists, so it is effectively taken out of circulation.

### Transfer Operation

| Field | | | |
|---|---|---|---|
| no. | Input | Output | Signature |
| 1. | Currency public | Currency public | Transfer signature |
| | key hash (p1h) | key hash (p2h) | (cryptographic signature of |
| | | | the Input and Output using |
| | | | currency secret key (s1) |
| 2. | Currency public | Value (v2) | |
| | key (p1) | | |
| 3. | | Recipient Flag | |
| | | (RF) | |

The TRANSFER operation is performed by the owner, or holder, of an amount of digital currency (i.e., the entity that has, or holds, the currency secret key (s1) for the amount of digital currency) by generating operation data (referred to for this operation as transfer data). The owner, or holder, may be a user entity 10 or a currency issuer entity 30, and may be referred to as the payer. The operation is to transfer ownership of the amount of digital currency to a different entity (for example, a different user entity 10), such that they then own or hold the amount of digital currency. This different entity may be referred to as the payee or recipient. Transfer of ownership of an amount requires the transfer in ownership of a currency secret key corresponding to the amount.

The Input data and Output data may be referred to as ‘currency data’. The Input data comprises the currency public key hash (p1h) (Input Field 1.) and the currency public key (p1) (Input Field 2.) corresponding to the amount of digital currency that the payer would like to transfer.

The Output data comprises a currency public key hash (p2h) (Output Field 1.), value (v2) (Output Field 2.) and a Recipient Flag (RF) (Output Field 3.). The currency public key hash (p2h) is a hash of the currency public key (p2) corresponding to the amount of digital currency that the recipient will own as a consequence of the transfer. The value (v2) is the value of the amount of digital currency that the recipient will own as a consequence of the transfer. Value v2 may be set to equal value v1, otherwise the verification entity 20 may deem the transfer data to be invalid (as explained in more detail in the ‘Verification of Operations’ section below). The Recipient Flag (RF) is data using which the recipient can identify that the transfer data may be relevant to them (as explained later).

The currency public key (p2) is generated in such a way that the recipient can derive the corresponding currency secret key (s2). One example way in which this may be achieved is for the payer to generate the currency public key hash (p2h) based on the recipient's public wallet key (pw). The recipient can then derive the corresponding currency secret key (s2) from the currency public key hash (p2h) and their wallet secret key (sw). This key generation process is described in detail in section 4 of the white paper ‘CryptoNote v 2.0’ by Nicholas van Saberhagen, published 17 Oct. 2013 (available at https://cryptonote.org/whitepaper.pdf). In particular, it is described in section 4.2.2 ‘Terminology’, section 4.3 ‘Unlinkable payments’ and section 4.5 ‘Standard CryptoNote transaction’. It will be appreciated that any suitable elliptic curve may be used.

Thus, only the recipient will be able to derive the currency secret key (s2) and so only the recipient will own, or control, the transferred amount of digital currency.

The recipient flag (RF) may be any data using which the recipient can identify which transfer data on the digital currency ledger might relate to them. In particular, after transfer data have been verified by a verification entity 20 and added to the digital currency ledger, the recipient may review the operation data on the digital currency ledger (which might include multiple sets of transfer data for transfers of different amounts of digital currency between different entities) and use the recipient flag (RF) to recognise which set of transfer data relates to them.

Optionally, the transfer data may not include a recipient flag (RF). However, in this case, in order to identify the set of transfer data that is relevant to them, and thus derive the currency secret key (s2), the recipient would need to go through all sets of transaction data on the digital currency ledger and speculatively derive a new secret key for each output amount of each set of transaction data. Since only the correct recipient of the transfer can derive the correct currency secret key (s2) (because only the correct recipient has the correct wallet secret key (sw)), they will then need to try each speculatively derived secret key against each corresponding set of transaction data to determine which set of transaction data relates to them. This would create a substantial processing burden for recipients, particularly where the recipient user entity 10 is using an electronic device with low processing power (such as a mobile electronic device) and/or has a slow data connection (such as a mobile data network like EDGE). Thus, preferably, the transfer data will comprise a recipient flag (RF).

The recipient flag (RF) may be the wallet public key (pw) and/or a hash of the wallet public key of the recipient. However, identifying the wallet public key (pw) and/or a hash of the wallet public key would eliminate anonymity for the recipient as any entity may identify the recipient from the transfer data. Therefore, entities may review the entire digital currency ledger and determine the total value of digital currency that each entity holds and how each entity has spent their amounts of digital currency.

Therefore, preferably the recipient flag (RF) would not be set to the wallet public key (pw) and/or a hash of the wallet public key. Instead, preferably it is set to a value that the recipient may recognise as being relevant to them, but which would not publically identify the recipient. For example, the recipient flag (RF) may be set to a truncated value of the public wallet key (pw) or a truncated value of the hash of the wallet public key, such as the first or last n bits (where n is any suitable value between 1 to the length of pw or the hash of pw, such as n=1, or n=4, or n=6, or n=8, or n=16, or n=24, etc) of the wallet public key (pw) or of the hash of the wallet public key. The recipient flag (RF) for one user entity 10 may therefore still be the same as (i.e., collide with) the recipient flag for a number of other user entities 10, such that the recipient is not uniquely identified.

The payer may themselves generate the recipient flag (RF) in this way, since they know the public wallet key (pw) or the hash of the public wallet key. Thus, the recipient flag (RF) may be generated by the payer in scenarios where the recipient (payee) has sent a payment request to the payer (wherein the payment request comprises the public wallet key (pw) and/or the hash of the public wallet key), and in scenarios where the payment is unsolicited (for example, where the recipient has made their public wallet key (pw), and/or the hash of their public wallet key, generally publically available and has not sent a specific payment request to the payer). Alternatively, in scenarios where the recipient has sent a payment request to the payer, the recipient may derive the recipient flag (RF) from the public wallet key (pw) and/or the hash of the public wallet key and include it in the payment request.

A recipient of a transfer may thus scan through all sets of transfer data in the digital currency ledger checking for any recipient flags (RF) that match a truncated value of their wallet public key (pw) or hash of their wallet public key. They may then speculatively derive a new secret key for each set of transfer data where there is a match and try each speculatively derived secret key against the corresponding set of transfer data to determine which set of transfer data relates to them. By first checking the recipient flag (RF), the number of speculative generations of secret keys should be substantially reduced, thus substantially reducing the processing burden whilst still not explicitly identifying the recipient (it is expected that a recipient flag (RF) of 16 bits might reduce the processing burden by 65,536 times, whilst still allowing a sufficient number of collisions with recipient flags of other user entities 10 to preserve anonymity).

In a further alternative, in scenarios where the recipient has sent a payment request to the payer, the recipient may derive the recipient flag (RF) in any suitable way, for example they may generate a unique recipient flag (RF) for every payment request they send to a payer (for example, by generating a nonce and setting the recipient flag (RF) to the nonce flag) and include it in the payment request. In this way, the recipient may keep a record in memory of the unique recipient flag (RF) and they may later scan through all sets of transfer data in the digital currency ledger and find the set of transfer data comprising their unique recipient flag (RF). They will then be able to derive the currency secret key (s2) for that set of transfer data. By uniquely identifying the set of transfer data in this way, the data processing burden for the recipient may be minimised, thus simplifying the process and increasing processing speeds. Furthermore, because the recipient can derive a different, unique recipient flag (RF) for each transfer in which they take part, anonymity may still be maintained, as there will be nothing publically linking different sets of transfer data on the digital currency ledger to the same recipient.

The payer generates the transfer signature (Signature Field 1.) by cryptographically signing the currency data using the currency secret key (s1). A verification entity 20 may thus use the currency public key (p1) to verify that the currency data were signed by the currency secret key (s1) and therefore verify that the transfer data were generated by the owner of the input amount (as explained in more detail in the ‘Verification of Operations’ section below).

In this example, the currency data comprises only one input amount of digital currency, represented by the currency public key hash (p1h) and the currency public key (p1) and one output amount of digital currency, represented by the currency public key hash (p2h). However, it will be appreciated that the currency may comprise two or more input amounts and/or two or more output amounts. This may be of use where an entity has multiple amounts of digital currency that they would like to transfer to another entity, and/or where an entity would like to transfer amounts to two or more different entities (for example, with one output amount being transferred to a payee and the other output amount being change that is returned to the payer). It is noted that for any output amount being transferred to the payer (i.e., change from the transaction), the payer will still preferably generate the currency public key hash for that amount using the wallet public key (pw), or hash of the wallet public key, in accordance with the CryptoNote technique identified above. In this way, the tracking key will still be operable for the output amount that is transferred to the payer.

Where there is one input amount and two or more output amounts, the operation may be considered to be a TRANSFER & SPLIT operation. In this case, the currency data may comprise a currency public key hash, a value and a recipient flag for each output amount.

Where there are two or more input amounts and one output amount, the operation may be considered to be a TRANSFER & JOIN operation. In this case, the currency data may comprise two or more signatures, each signature being generated using a currency secret key corresponding to each input amount (analogously to the JOIN operation described above).

Where there are two or more input amounts and two or more output amounts, the operation may be considered to be a TRANSFER & JOIN & SPLIT operation. In this case, the currency data may comprise a currency public key hash, a value and a recipient flag for each output amount, and two or more signatures, each signature being generated using a currency secret key corresponding to each input amount.

After creating the transfer data, it may be communicated to the verification entities 20 by the payer. If verified as being valid, the recipient will then hold, or own, the output amount of digital currency, by virtue of the fact that they are able to derive the corresponding currency secret key.

Thus, it can be seen that a user entity 10 may have a single wallet public key (pw) using which they can receive multiple different amounts of digital currency from different entities in the network 200. Anonymity is maintained because the operation data identifies each input and output amount of digital currency using a currency public key and/or currency public key hash, which is unique to the amount of digital currency itself. The currency public key and/or currency public key hash are not linked to the owners of the amounts and there is no other data in the operation data that uniquely identifies the owners of the amounts. Therefore, it is no longer necessary for a user entity to generate a new public-private key pair for every amount of digital currency they would like to receive, and keep each of the private keys safe. Instead, they need only keep the wallet secret key (sw) safe, using which they may then derive a currency secret key as and when they wish to perform an operation on an amount of digital currency.

It can also be seen that, with the exception of destroy data, operation data effectively creates a new amount of digital currency. This is because amounts of digital currency are identified by a currency public key hash, and each set of operation data will comprise a new currency public key hash. Any amounts of digital currency identified in the Input data (i.e., any currency public key hashes in the Input data) will effectively be deleted by the operation because after the operation data has been added to the digital currency ledger, a new amount(s) (i.e., the output amount(s)) is considered to have replaced the old amount (i.e., the input amount(s)) and those old amounts will be deemed to have used/spent (as will be seen later). Thus, the amounts of digital currency may be considered to be ‘one time amounts’ that may be used only once, after which they become invalid and irrelevant. This enables blocks in the digital currency ledger that identify only used/spent amounts to be safely deleted as those amounts are no longer relevant (as can be seen in the ‘Adding operation data to the digital currency ledger’ section below).

In a further variation, a CREATE&TRANSFER operation may be performed by a currency issuer 30 by generating operation data as explained above in “CREATE OPERATION”, but rather than deriving the currency public key (p1) and currency secret key (s1) using standard public-private key pair generation techniques, the currency public key (p1) may be derived based on the recipient's public wallet key (pw). The recipient can then derive the corresponding currency secret key (s1) from the currency public key hash (p1h) and their wallet secret key (sw). This key generation process is described in detail in section 4 of the white paper ‘CryptoNote v 2.0’ by Nicholas van Saberhagen, published 17 Oct. 2013 (available at https://cryptonote.org/whitepaper.pdf). In particular, it is described in section 4.2.2 ‘Terminology’, section 4.3 ‘Unlinkable payments’ and section 4.5 ‘Standard CryptoNote transaction’. It will be appreciated that any suitable elliptic curve may be used. Thus, the currency issuer 30 would not ‘own’ the amount of digital currency created by the create & transfer data—the recipient would own the amount of digital currency created by the create & transfer data.

The CREATE&TRANSFER operation may comprise two or more amounts of digital currency, each with their own currency public key. The currency public key for each amount intended for a recipient party that is not the currency issuer 30 may be generated based on the recipient's public wallet key (pw). The currency public key for each amount intended for the currency issuer 30 (i.e., the amount that is to remain under the control of the currency issuer) may be generated using standard public-private key pair generation techniques.

### Verification of Operations

A verification entity 20 may be any entity that has been provided with a verifier private, or secret, key (sv). The verifier secret key (sv) will have a corresponding verifier public key (pv) that is obtainable by any other entity in the network 200.

The verifier secret key (sv) and verifier public key (pv) are a public-private key pair and may be generated by the primary authority 50 using any suitable cryptographic technique. By providing the verifier secret key (sv) to a verification entity 20, the primary authority 50 acknowledges that that entity is a trusted verification entity. Alternatively, the verifier secret key (sv) and verifier public key (pv) may be generated by the verification entity 20 and the primary authority may signal that the verification entity 20 is a trusted entity by adding the verifier public key (pv) to a key block chain and/or provisioning it to entities in the network 200 (for example, by including it as at least part of the digital currency software).

The verifier public key (pv) may be included in a key block chain (which may be the same key block chain for the currency creator public key (pb) and/or currency destroyer public key (pd), or may be a different key block chain) that is publically available to all entities in the network 200. For example, it may be maintained and provided by the primary authority 50, or any other suitable entity in the network 200. Additionally or alternatively, the verifier public key (pv) may be included as part of the digital currency software provided to the entities in the network 200.

A verification entity 20 may obtain operation data because the data are sent to the verification entity 20 from a user entity 10, a currency issuer 30 or a currency destroyer 40 (for example, by sending it to a network of verification entities, or just a single verification entity 20), or by retrieving it from a location to which user entities 10, currency issuers 30 and/or currency destroyers 40 may post operation data (for example, an area hosted by the primary authority 50, or any other suitable entity).

After a verification entity 20 has obtained operation data that have been created by a user entity 10, a currency issuer 30 or a currency destroyer 40, it may carry out a verification process. The verification process comprises checking the signature in the data and, where necessary, the values in the data.

The signature in the operation data may be checked by decrypting the signature using the relevant public key and checking that the decrypted data matches the currency data (i.e., the input and/or output data) of the operation.

For create data, the verification entity 20 may obtain the currency issuer public key (pb), for example from a public key block chain or from memory in the verification entity 20 (where the currency creator public key (pb) was included as part of the digital currency software provided to the verification entity 20, or where it has previously obtained the currency creator public key (pb) from the public key block chain and then saved it in memory). The new currency signature may then be decrypted and compared with the currency data (i.e., the Output data) of the create data.

Likewise, for destroy data, the verification entity 20 may obtain the currency destroyer public key (pd) in an analogous way to that of the currency creator public key (pb). The currency destroy signature may then be decrypted and compared with the currency data (i.e., the Input data) of the destroy data.

For split data, the verification entity 20 will use the currency public key (p1) to decrypt the split signature and compare the decrypted data with the currency data (i.e., the Input and Output data) of the split data. For join data, the verification entity 20 will use the currency public key (p1) to decrypt join signature 1 and compare the decrypted data with the currency data of the split data, and use the currency public key (p2) to decrypt join signature 2 and compare the decrypted data with the currency data of the split operation. Likewise, for operation data from a SPLIT & JOIN operation, the verification entity 20 will use the currency public key (p1) to decrypt join signature 1 and compare the decrypted data with the currency data (i.e., the Input and Output data), and use the currency public key (p2) to decrypt join signature 2 and compare the decrypted data with the currency data.

For transfer data, or operation data from a TRANSFER & SPLIT operation, the verification entity 20 will use the currency public key (p1) to decrypt the transfer signature and compare the decrypted data with the currency data (i.e., the Input and Output data). For data from a TRANSFER & JOIN operation, or a TRANSFER & JOIN & SPLIT operation, the verification entity 20 will use the currency public key (p1) to decrypt the transfer signature 1 and compare the decrypted data with the currency data, and use the currency public key (p2) to decrypt transfer signature 2 and compare the decrypted data with the currency data.

If the decrypted data matches the currency data, the signature is verified as correct.

If the decrypted data does not match the currency data, which may be a consequence of an unauthorised entity, or an entity that does not own the input amount of digital currency (i.e., an entity that does not have the correct currency secret key), creating the signature, the signature is identified as incorrect. Upon identification of an incorrect signature, the verification process is considered to have a negative verification outcome and the verification entity 20 may discard the operation data so that it does not get added to the digital currency ledger. The desired digital currency action (for example, a transfer of an amount of digital currency, or a split of an amount of digital currency, etc) therefore will not take place.

With the exception of create and destroy data, the verification entity 20 will also check the input and output values to ensure that they conform with requirements. The requirements may be that the total input value equals the total output value. Alternatively, the requirements may be that the total output value is equal to or less than the total input value. In this instance, any different between the output value and input value may be taken by the verification entity 20 as a verification commission.

The output value(s) is identified in the Output data of the operation data. The value of each input amount of digital currency may be determined by checking the digital currency ledger to identify the set of operation data where that amount was output (for example, by using the currency public key hash (p1h) to look up the previous set of operation data where the currency public key hash (p1h) appears in the Output data and read off the value (v1) from that set of operation data).

Optionally, the verification entity 20 may also check create data and/or destroy data to ensure that the input or output values (as appropriate) conform with requirements. In this instance, the requirements may be that there is a maximum value that can be created or destroyed.

If the total input and output values conform with requirements, the values in the operation data are verified as correct.

If the input and output values do not conform with requirements, the verification process is considered to have a negative verification outcome and the verification entity 20 may discard the operation data so that it does not get added to the digital currency ledger. The desired digital currency action therefore does not take place.

Finally, the verification entity 20 may check that any input amounts of digital currency are still ‘active’/‘valid’ (for example, they have not already been used/spent). To do this, the verification entity 20 may check the digital currency ledger to ensure that each input amount in the operation data has not previously been used as an input to any sets of operation data in the digital currency ledger (for example, by checking that the amount public key hash (p1h) has not appeared in the Input data of any sets of operation data in the digital currency ledger).

If each input amount in the operation data is active/valid, the input amount(s) are verified as correct.

If any input amount in the operation data is not active/valid (for example, it has been used as an input amount in a set of operation data in the digital currency ledger), the verification process is considered to have a negative verification outcome and the verification entity 20 may discard the operation data so that it does not get added to the digital currency ledger. The desired digital currency action therefore does not take place. Thus, double spending of the same amount may be prevented.

If all steps of the verification process are successfully passed, the verification process is considered to have a positive verification outcome and the operation data may be added to the digital currency ledger by the verification entity 20.

### Adding Operation Data to the Digital Currency Ledger

To add verified operation data to the digital currency ledger, the verification entity 20 adds the operation data to a new block. All sets of operation data that have been positively verified in a period of time are added to the new block and at the end of the period of time, the verification entity 20 adds the new block to the digital currency ledger.

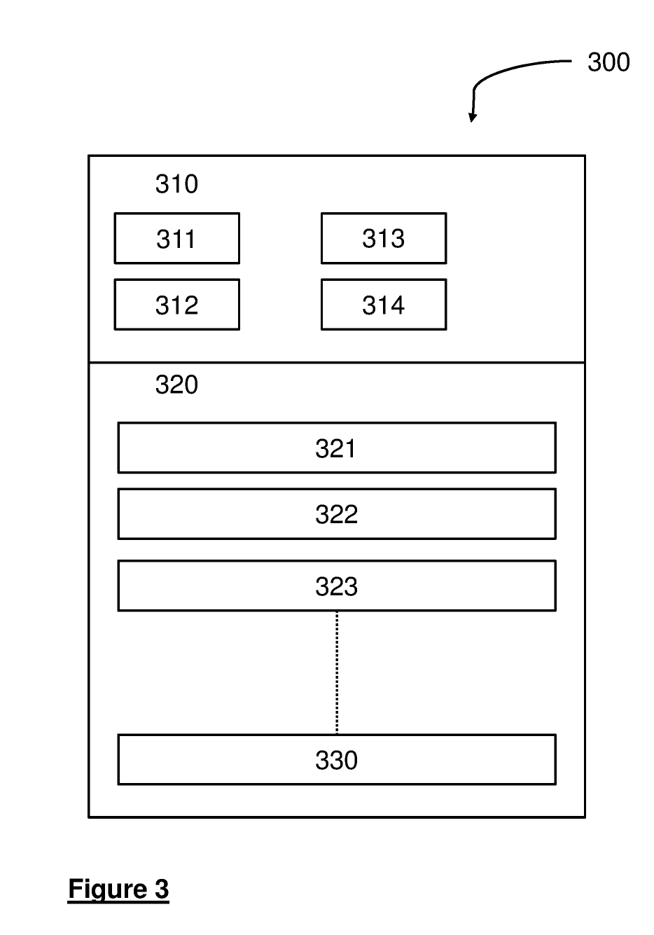

FIG. 3 shows an example representation of a new block 300. The new block 300 comprises a block header 310 and sets of operation data 320.

Once the verification entity has created the new block 300, it may be added to the digital currency ledger in a number of different ways. For example, it may be broadcast to all entities in the network 200, using a P2P network. Thus, all entities in the network 200 will have the new block 300 to add to their copy of the digital currency ledger. Additionally, or alternatively, an entity (for example, the primary authority 50) may keep a publically available copy of the digital currency ledger. The new block 300 may thus be provided to that entity, who may then add it to the publically available copy of the digital currency ledger.

The block header 310 comprises a block number 311, a hash of the most recent previous block that appeared in the digital currency ledger 312, a time stamp 314, and optionally an identifier of the oldest active block in the digital currency ledger 313. The block header 310 may optionally also comprise a merkle root for a merkle tree of hashes of sets of operation data and/or the number of sets of operation data contained in the block 300. The block number 311 will uniquely identify the new block 300 and may be set to a value that is one greater than most recent previous block in the digital currency ledger. The hash of the most recent previous block in the digital currency ledger 312 is used to tie the new block 300 to the most recent previous block (i.e., chain them together). The time stamp 314 indicates when the new block 300 was created. The optional identifier of the oldest active block in the digital currency ledger 313 is described in more detail below.

The sets of operation data 320 comprise each set of operation data 321, 322, 323 . . . that has been verified in the period of time. The sets of operation data 320 also comprise verification data 330. The verification data 330 are created by the verification entity 20 to signal that they have verified each set of operation data 321, 322, 323, . . . The verification data 330 comprise endorsement data, for example an identifier of the verification entity 20, and a verification signature that the verification entity 20 generates by cryptographically signing the endorsement data using their verifier secret key (sv). By including verification data 330 in the new block 300, after the new block 300 has been added to the digital currency ledger, any entity in the network 200 may obtain the verifier public key (pv) (for example by looking it up on a key block chain using the identifier of the verification entity 20, or from memory in the entity) and verify that the verification signature has been correctly generated. If the verification signature has not been correctly generated, action may be taken to delete the new block 300 from the digital currency ledger (for example, by the primary authority 50), or other verification entities 20 may simply ignore the new block and continue to work on their own new block to be added to the digital currency ledger. If the signature has been correctly generated, other verification entities 20 may signal their acceptance of the new block 300 by starting work on a further new block, which would include a hash of the new block 300 (thus chaining the further new block to block 300).

In addition to, or as an alternative to, including the verification data 330 in the sets of operation data 320, they may be included in in any other suitable part of the new block 300, for example in the block header 310. Furthermore, the verification signature may be generated by cryptographically signing any data in the new block 300 using the verifier secret key (sv). In this case, the verification data may or may not comprise an identifier of the verification entity 20.

Some or all verification entities 20 (and optionally also the primary authority 50) in the network 200 may monitor the behaviour of the verification entities 20 using a consensus algorithm. If the consensus algorithm identifies that one of the verification entities 20 is not operating correctly (for example, they are validating sets of operation data that are invalid, or they are not generating their verification signature correctly, etc), action may be taken against the verification entity 20, for example to remove their public key from the key block chain and/or remove their certificate corresponding to the verification secret key (sv) such that that verification entity 20 can no longer verify operations. The consensus algorithm may take any suitable form, for example an n-from-n scheme. In one particular example, a new block may only be accepted by the entities in the digital currency network 200 if a minimum number of verification signatures are included in it. For example, one verification entity 20 may check the block and broadcast it with their signature. A second verification entity 20 may then check that block and if they also verify it, add their signature to the block and rebroadcast it. This may go on until a minimum acceptable number of signatures have been added by different verification entities (for example, 3, or 4, etc), at which time the block will be accepted by the entities in the network 200 and work on the next block may begin. In a further example, one verification entity may act as a primary signatory and one or more further verification entities may act as secondary signatories. The network 200 may be configured such that a new block 300 is only accepted by the entities if it includes a signature from the primary entity and at least one secondary signatory.

In this way, improper behaviour from a verification entity 20 (for example, verifying operation data as correct when in fact that operation data should be discarded) may be identified and appropriate action taken (for example, removing their public key from the key block chain, etc). In this way, the network 200 may be protected against a compromised, rogue or badly implemented verification entity 20 that is habitually creating invalid blocks 300.

As part of creating a new block 300, the verification entity 20 may optionally also set a value for the identifier of the oldest active block in the digital currency ledger 313. The identifier 313 will identify the oldest block in the digital currency ledger that has at least one set of operation data identifying at least one ‘active’/‘valid’ output amount of digital currency (i.e., a currency public key hash that has not appeared in the operation data of any subsequent block in the digital currency ledger). All blocks prior to the identified block will not identify any active/valid output amounts of digital currency and are therefore no longer of any relevance.

The verification entity 20 may recognise the chronological order of the blocks in the digital currency ledger using the block number 311 and/or the time stamp 314. The verification entity 20 may set the identifier 313 in the new block 300 by looking at the oldest active block identified in the block header of the most recent previous block in the digital currency ledger. If the sets of operation data 320 in that block no longer identify any active/valid amounts of digital currency, i.e. all amounts identified in that block have been used or spent, as explained earlier (for example, because all of the currency public key hashes in the Output data in that block have appeared in the operation data of subsequent blocks and/or in the sets of operation data 320 of the new block 300), the verification entity 20 will review the digital currency ledger to identify the next oldest active block and set the identifier 313 accordingly. Thus, as old amounts of digital currency are used/spent, the identifier 313 may be updated such that the oldest active block is always identified.

As part of this process, optionally a chain of block headers for ‘archived’ blocks (i.e., blocks that are older than the oldest active block may be kept. Thus, a the digital currency ledger may comprise the ‘active’ part of the digital currency ledger (i.e., the oldest active block and all subsequent blocks) and historic (archived) block headers for blocks that are older than the oldest active block. Some record of all of the blocks that have ever been added to the digital currency ledger, whilst still keeping the size of the digital currency ledger to a minimum (because the size of the block header in each block is typically only a small fraction of the data size of the operation data in the block).

Because the verification entity 20 is a trusted entity and a block added by the verification entity 20 can be quickly authenticated using the verification data 330 and the verifier public key (pv), the identifier 313 may be trusted by other entities.

Additionally, or alternatively, the identifier 313 may be in any suitable part of the block, for example in the sets of operation data 320 as part of a dedicated set of identifier operation data and/or as part of verification data 330, etc.

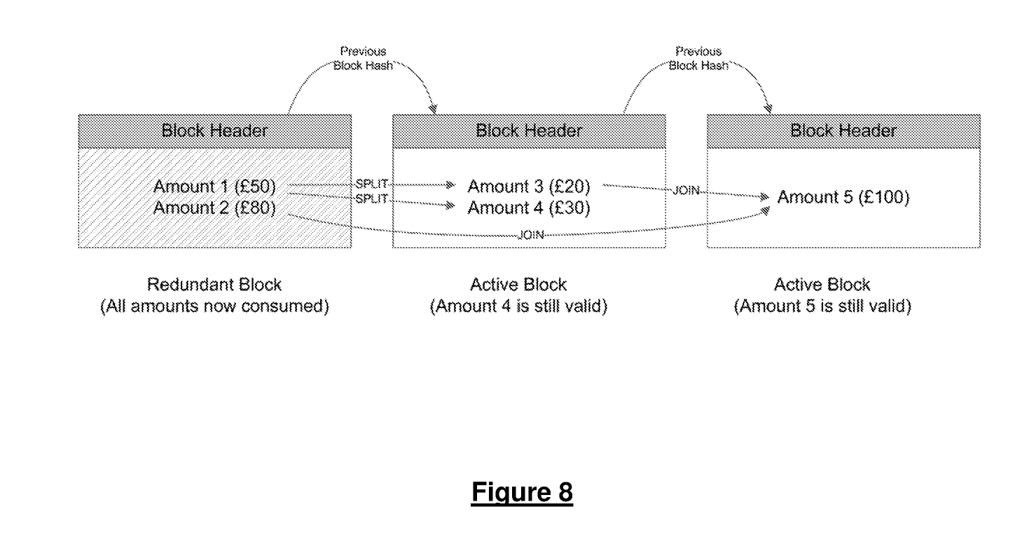

FIG. 8 shows an example representation of blocks in the digital currency ledger. The blocks are represented in chronological order with the oldest block left-most and the newest block right-most. As can be seen, two amounts of digital currency are represented in the oldest-block (Amount 1 and Amount 2). Amount 1 is split to create Amount 3 and Amount 4. Amount 1 is therefore no longer valid/active. Amount 2 is then joined with Amount 3 to create Amount 5. Amount 2 and Amount 3 are therefore no longer valid/active. Thus, as can be seen, the oldest block no longer identifies any active/valid amounts of digital currency and is therefore a redundant block. The next block still identifies an active/valid amount of digital currency (Amount 4) and is thus the oldest active block. The identifier 313 may therefore be set to identify that block as the oldest active block.

Thus, when entities are reviewing the digital currency ledger to verify operation data and new blocks, they may look at the identifier 313 in the most recent block on the digital currency ledger and then only review the digital currency ledger as far back as the block identified by identifier 313. This is because used/spent amounts are irrelevant by virtue of the ‘one time’ nature of the digital currency (as explained earlier), so only valid/active amounts need be considered. Thus, the verification process for verification entities 20, and also the checking of new blocks by any other entities in the network 200, may be made more efficient and less data intensive because it is not necessary to review the entire digital currency ledger. Optionally, if the entity keeps a local copy of the digital currency ledger, they may discard all blocks prior to the block identified by identifier 313, thus reducing the amount of data they must store.

Furthermore, when a new entity is joining the network 200, they need only download the digital currency ledger as far back as the block identified by identifier 313. For example, if they seek to obtain the digital currency ledger from an entity in the network 200, that entity may provide them with the digital currency ledger only as far back as the block identified by identifier 313 (and optionally as part of the digital currency ledger, the historic (archived) block headers). Likewise, if the primary authority 50 is keeping a publically available copy of the digital currency ledger, they may discard all blocks prior to the block identified by identifier 313 (and optionally update the historic (archived) block headers accordingly) thus reducing the size of the publically available digital currency ledger. This reduces the amount of data that must be downloaded, thereby making it more straightforward for new entities to join the network 200, particularly when the new entity has a low bandwidth connection to the network 200 and/or is operating a device with low processing power (such as a mobile device).

As part of this process, the verification entity 20 may optionally archive old amounts of digital currency. For example, the verification entity 20 may recognise that the oldest active block on the digital currency ledger identifies only a small number of active amounts of digital currency and that if these amounts are archived, the oldest active block would move forward by a substantial number of blocks (i.e., a large number of blocks could be discarded from the digital currency ledger). The verification entity 20 may archive old amounts of digital currency by taking the old set of operation data relating to each old amount and copy it into the set of operations 320 of the new block 300. Because the output amount of digital currency identified in the old set of operation data would then appear as an output amount in the sets of operation data 320 in the new block 300, the old amount would no longer be active/valid. The oldest active block in the digital currency ledger will thus be moved forward (i.e., it will now be a more recent block) and the verification entity 20 may set the identifier 313 accordingly.

Additionally, or alternatively, a currency destroyer 40 may assist in archiving older amounts. The currency destroyer 40 may identify an old amount(s) of digital currency and destroy it by generating destroy data (as above). The destroy data will then be communicated to the verification entities 20 who will include it in the sets of operation data 320 in a new block 300 and set the identifier 313 accordingly.

Optionally, the destroyed amount of digital currency may be recreated using create data to create digital currency to the same value as the destroyed amount and then transferred to the owner of the destroyed amount using transfer data (for example, where the currency destroyer 40 is also a currency creator 30). The owner will be able to recognise the transfer data that are relevant to them (for example, using the Recipient Identifier (RF)) and derive the currency secret key corresponding to the amount of digital currency output from the transfer data, thus maintaining ownership of an amount of digital currency that has the same value as the amount that was destroyed. Alternatively, the currency destroyer 40 may keep a record of the destroyed amount of digital currency and recreate an amount to the same value and transfer it to the owner of the destroyed amount when the owner requires it (for example, when the owner submits a request to the primary authority 50). Or, they may donate the destroyed amount to charity (for example, where the destroyed amount is of a low value). Or, they may keep the destroyed amount as profit (for example, where the destroyed amount is of a low value). How the currency destroyer 40 goes about archiving older amounts may depend on configuration and policy of the network 200.

When setting the identifier 313, verification entities 20 may either consider the operation data in the sets of operation data 320 (such that an operation on an old amount of digital currency will have an immediate effect on the identifier 313), or they may consider only operation data in blocks already in the digital currency ledger (such that an operation on an old amount of digital currency will only have an effect on the identifier 313 when the next block is created).

By archiving older amounts in this way, the oldest active block in the digital currency ledger may be moved forward (i.e., made to be a more recent block) more quickly, thereby reducing even further the size of the digital currency ledger. This may even further improve efficiency of verifying operation data and new blocks and may even further reduce data download burdens for new entities, thus making the network 200 more accessible to new entities.

In an alternative where the new block 300 does not comprise identifier 313, any entity in the network 200 may still review the digital currency ledger for themselves to identify the oldest active block and then discard all earliest blocks from their copy of the digital currency ledger. In this way, the size of the digital currency ledger that they must store may be reduced. Thus, even when the new block 300 does not comprise identifier 313, archiving older amounts of digital currency as explained above may still be beneficial as it may enable a further reduction to the size of the digital currency ledger that entities in the network 200 store.

### Key Block Chains

At least one key block chain may be used to distribute and manage currency issuer public keys (pb), currency destroyer public keys (pd) and/or verifier public keys (pv). A single key block chain may be used for all different types of public keys, or a different key block chain may be used for each different type of public key required for the digital currency system.

The primary authority 50 may administer the key block chain(s) by virtue of ownership of a secret master key. A new public key (for example, a new currency issuer public key (pb)) may be added to the key block chain by virtue of the primary authority 50 creating key block data for the new public key and adding it to the key block chain.

The key block data comprises public key data and a master signature, generated by cryptographically signing the public key data with the secret master key. The public key data may comprise the public key (for example, a currency destroyer public key (pd) and an identifier of the entity to which the public key corresponds (for example, the currency destroyer 40 corresponding to the currency destroyer public key (pd)). Thus, in order to check the signature in create data, destroy data, or verification data, an entity may use the identifier included in the create data, destroy data, or verification data, to look up the corresponding public key in the key block chain, and thus verify the signature.

The master signature is included in the key block data in order to prove that the public key data has come from the primary authority 50, and is therefore trustworthy. A public master key corresponding to the secret master key may be distributed, or made available to, the network 200 by any suitable means, for example by including it as at least part of the digital currency software, or via certificate authorities, etc. Thus, whenever an entity retrieves a public key from the key block chain, the public key data may be checked using the master signature and the public master key in order to verify that the public key data has come from the primary authority 50.

The public key data may also comprise an expiry date for the public key, which may be checked when a public key is being retrieved from the key block chain, in order to verify that it is still valid.

The key block data may be added to the key block chain in an analogous manner to the addition of operation data to the digital currency ledger. For example, a block may be created comprising the key block data (and the key block data for any other public keys that the primary authority 50 wishes to put on the key block chain) and a block header. The block header may comprise at least one of a block number, a hash of the previous block in the key block chain and/or a time stamp. The block may then be added to the key block chain by, for example, broadcasting it to all entities in the network 200, using a P2P network, storing it in a location known to, and accessible by, the entities in the network 200, and/or adding it to their copy of the key block chain, which is then supplied to any entity that requests it, etc.

Optionally, the primary authority 50 may perform a key revoke operation in order to revoke a key that has been issued to an entity. For example, it may be recognised that a secret key belonging to a currency issuer 30, currency destroyer 40 or verification entity 20 has been compromised, or a currency issuer 30, currency destroyer 40 or verification entity 20 may wish to leave the digital currency system, in which case the corresponding public key should be made invalid. In this way, any signatures allegedly signed by the relevant entity could not be authenticated as their corresponding public key would be marked a revoked in the key block chain. The key revoke operation generates key revoke data, which may take the same form as the key block data but further comprise a flag to indicate that the public key has been revoked and is therefore now invalid. In one example, it may be indicated that the public key has been revoked and is therefore now invalid by setting the expiry date in the public key data to a date in the past. Since other entities in the network 200 may be configured to consider only the most recent block in the key block chain that identifies a particular public key and ignore all earlier blocks identifying the same public key, they will consider the public key to be invalid and therefore revoked. In this way, the expiry date may act as the flag to indicate that the public key has been revoked. In a further example, the public key data may comprise a further data field, which may be set by the primary authority 50 to a value indicating that the public key in the public key data has been revoked. The key revoke data may be added to the key block chain in the same way as the key block data.

In an alternative, rather than just the primary authority 50 having the authority to add new keys to the key block chain, (and/or revoke keys already in the key block chain) a new key may be added to the key block chain by a consortium. The system may be configured to comprise a consortium of two or more equal peers who may vote on the addition of a new key, for example requiring 4 out of 5 peers to approve a new key before it is accepted onto the key block chain. Such an arrangement may be achieved in any suitable way, for example by requiring the peers to vote amongst themselves before a nominated one of the peers adds the key block data (and/or key revoke data) to the key block chain, or by each of the peers adding the key block data (and/or key revoke data) to the key block chain and other entities in the network 200 only treating the key block data (and/or key revoke data) as valid if it appears in the key block chain a required number of times, etc.

In a further alternative, rather than using a separate key block chain(s), the key block data and/or key revoke data may be added to the digital currency ledger. For example, key block data and/or key revoke data may be included as further data sets in the operation data 320 of a block 300 before the block is added to the digital currency ledger.

In addition to, or as an alternative to, the key block chain, public keys may be made available by any other suitable means, for example via certification authorities and/or by issuing updates to the digital currency software, etc.

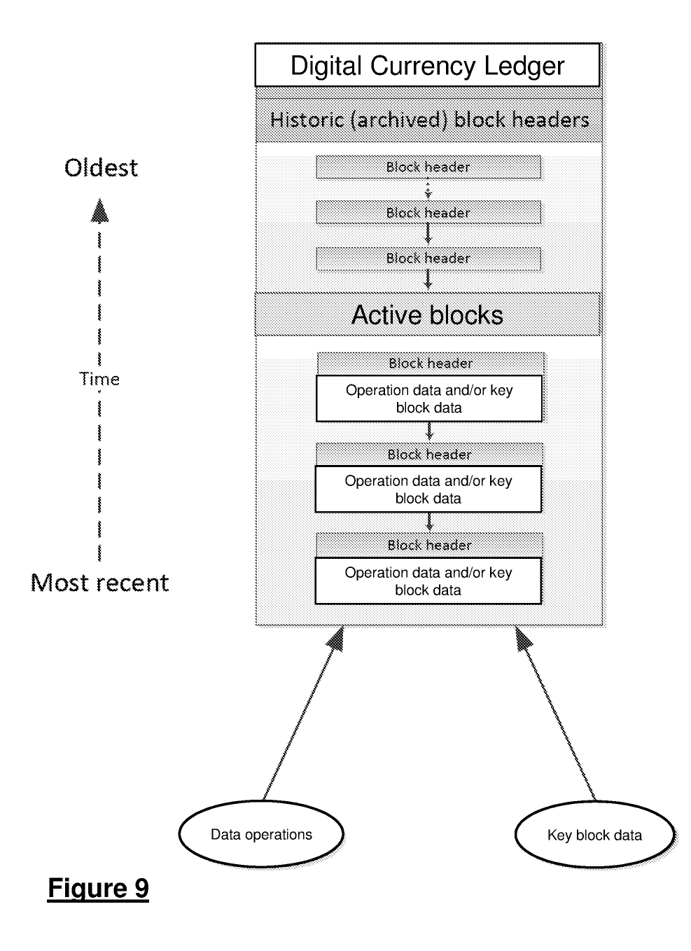

FIG. 9 shows an example representation of the digital currency ledger. As can be seen, the digital currency ledger in this example comprises a chain of block headers for archived blocks of the digital currency ledger (as described earlier) and the chain of ‘active’ blocks (i.e., the ‘active’ part of the digital currency ledger, as described earlier). In this example, both operation data and key block data are included in the blocks of the digital currency ledger, such that the key block chain is effectively part of the digital currency ledger.

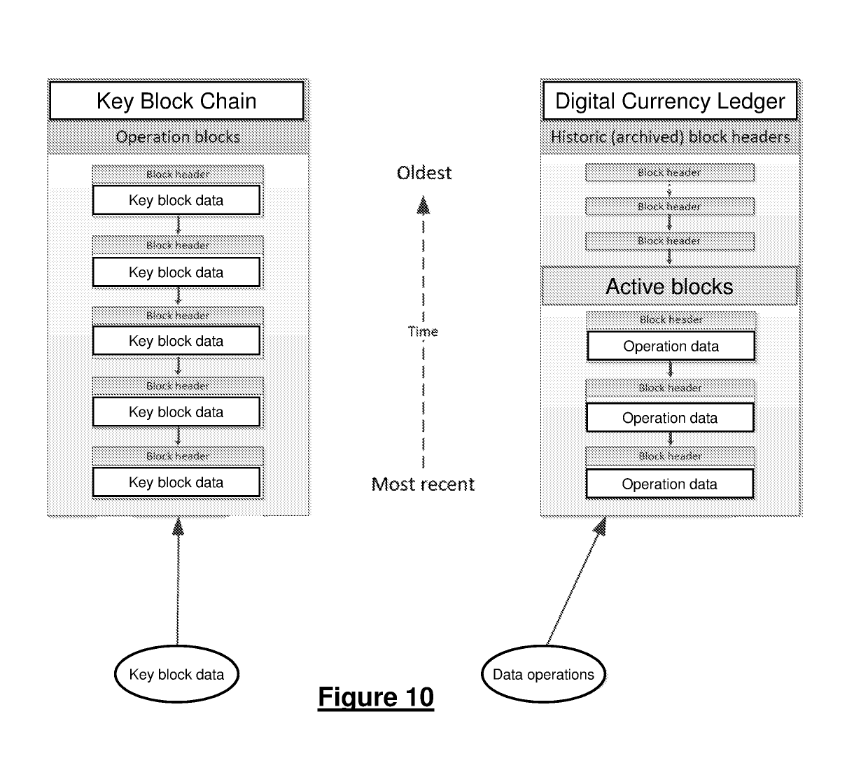

FIG. 10 shows a further example representation of the digital currency ledger and separate key block chain. The digital currency ledger is very similar to that represented in FIG. 9, but only operation data are included in the blocks of the digital currency ledger. The key block data are included in blocks of a separate block chain—the key block chain.

### Tracking Keys

A user entity 20 may generate their wallet public key (pw), wallet secret key (sw) and a corresponding tracking key in accordance with the key generation process described in detail in section 4 of the white paper ‘CryptoNote v 2.0’ by Nicholas van Saberhagen, published 17 Oct. 2013 (available at https://cryptonote.org/whitepaper.pdf) (in particular, in section 4.2.2 ‘Terminology’, section 4.3 ‘Unlinkable payments’ and section 4.5 ‘Standard CryptoNote transaction’). It will be appreciated that any suitable elliptic curve may be used.

The user entity 20 may supply the wallet public key (pw) (and/or hash of the wallet public key) and corresponding tracking key to the primary authority 50. Knowledge of the tracking key and wallet public key (pw) (and/or hash of the wallet public key (pw)) enables the primary authority 50 to identify and link together from the digital currency ledger all amounts of digital currency being transferred into or out of the user entity's wallet. Thus, the primary authority 50 may keep a record of all amounts of digital currency owned by the user entity 20. However, because the primary authority 50 will not know the amount secret key corresponding to any of those amounts of digital currency, the primary authority 50 will not have control over any of the amounts of digital currency. Furthermore, the digital currency ledger will still not publically link any of the amounts to the particular user entity 20, such that only the primary authority 20 may be able to link the amounts and public anonymity is still preserved for the user entity 20.

The primary authority 50 may keep a record of the tracking key and wallet public key (pw) (and/or hash of the wallet public key) along with any other suitable information relating to the user entity 20, for example at least one of their name, address, bank details, email address, telephone number, device identifier (such as IMSI, MSISDN, MAC address, etc) for the electronic device that the user entity 20 uses, etc.

The tracking key may be of particular use where the primary authority 50 is a trusted entity such as a bank, which may be required by legislation and/or banking codes of conduct, etc to keep track of user transactions (for example, to help prevent financial crimes, etc). It may also be useful for the user entity 20 as if they lose at least one of their amount secret keys (for example, because they lose the device on which they are stored, etc), they may approach the primary authority 50, who may use the tracking key to verify which amounts of digital currency the user entity 20 owns, destroy them (using the DESTROY operation), create new amounts to the same value (using the CREATE operation) and transfer the amounts back to the user entity 20 (using the TRANSFER operation). Thus, the user entity 20 will not lose the amount(s) simply because they have lost their amount secret key(s).

Where there are two or more primary authorities 50, each user entity 20 may register with only one primary authority, who may keep a record of the tracking key and wallet public key (pw) (and/or hash of the wallet public key). At least part of the wallet public key (pw) (for example, the first three digits) may identify the primary authority 50 that keeps a record of the tracking key and wallet public key (pw) (and/or hash of the wallet public key) for the user.

Optionally, the digital currency system may be configured to require each user entity 10 to register their tracking key and wallet public key (pw) (and/or hash of the wallet public key) before they may successfully perform any digital currency operations. In one example, after a user entity 10 has registered their tracking key and wallet public key (pw) (and/or hash of the wallet public key) with the primary authority 50, the primary authority 50 may supply a group secret key to the user entity 10. The user entity 10 may store the group secret key and may be configured to include a group signature in any operation data that they generate in the future. The group signature may be generated by cryptographically signing at least part of the currency data in the operation data using the group secret key. Thus, the operation data that is provided to the verification entities 20 will comprise at least two signatures—the group signature and the transfer/split/join signature. In addition to the verification processes described above, a verification entity 20 may also obtain a group public key corresponding to the group private key (for example, from a key block chain or from their digital currency software) and verify the group signature. Only if all signatures in the operation data are verified may the verification entity 20 include the operation data in a new block. In this way, if a user entity 10 did not register with the primary authority 50 and obtain a group private key, they may not perform any operations.

In an alternative to the above, the primary authority 50 may generate the tracking key, wallet public key (pw) and wallet secret key (sw) and supply these (optionally with the group private key) to the user entity 20. However, this may not be preferable, as the primary authority 50 will know the wallet secret key (sw) and may therefore derive amount secret keys for the amounts transferred to the wallet of the user entity 20.

In a further alternative, tracking keys may not be generated or used at all as part of the digital currency system.

### Example Use Scenarios

By way of example only, some uses of the digital currency of the present disclosure are described below.

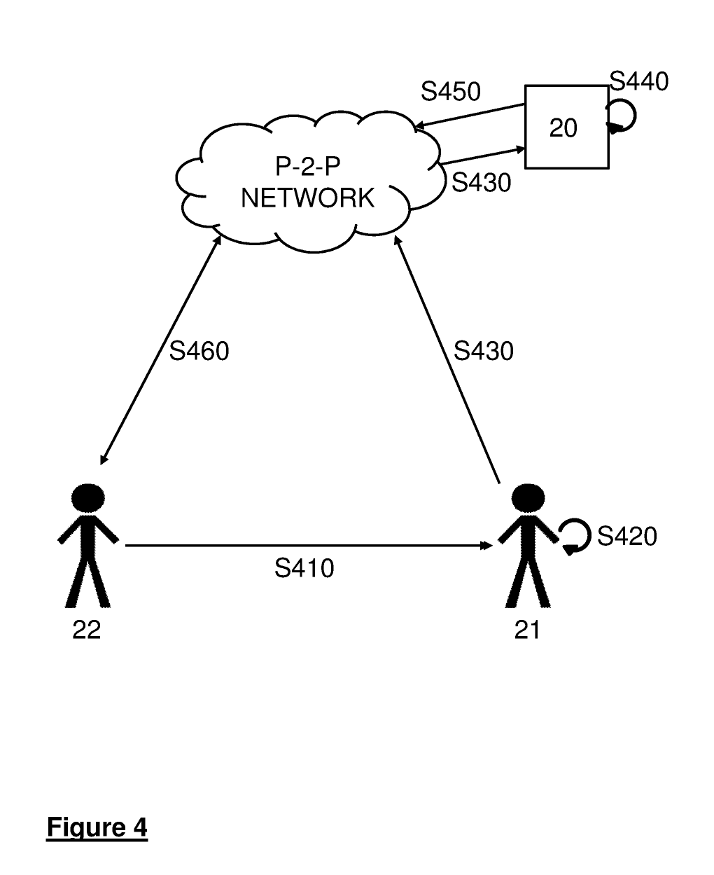

FIG. 4 shows an example of a customer (payer) 21 wishing to purchase a product from a merchant (payee) 22. In this case, the customer 21 and merchant 22 are different user entities 20 in the network 200.

In Step S410, the merchant 22 communicates their public wallet key (pw) to the customer 21 and the value of digital currency that they would like to be transferred to them. This information may be communicated in any suitable way depending on the purchase situation. For example, if the customer 21 is in the merchant's shop 22, the merchant may communicate the information from the merchant's electronic device to the customer's electronic device using any suitable communications technology, such as Bluetooth, NFC, SMS message, email, infra-red (IR) communication, in a QR code (or any other form of visual code) that is displayed on the merchant's electronic device for scanning by the customer's electronic device, etc. Alternatively, if the purchase is an internet based purchase, the merchant 22 may communicate the information in a QR code on a check-out page of their website, or via an email, or via a digital currency payment portal in the check-out page, etc.

Upon receipt of the information, in Step S420 the customer 21 performs the necessary operation. For example, the information may be imported into the digital currency software operating on the customer's electronic device (for example, because the customer 21 has scanned the QR code using their software, or because the information is arranged so as to launch the digital currency software with the information imported into it) and the operation data may be created as described above. The electronic currency software may perform a TRANSFER, or TRANSFER&SPLIT, or TRANSFER& JOIN, TRANSFER& JOIN&SPLIT operation as necessary, depending on the amounts of digital currency that the customer 21 has and the value of the amount that is to be transferred to the merchant 22.

In step S430, the operation data is communicated to at least one verification entity 20 in the network 200 as described above. In Step S440, the verification entity 20 carries out verification as described above. If the operation data is positively verified, in Step S450 the verification entity 20 adds a new block 300 to the digital currency ledger, wherein the new block 300 includes the operation data.

In Step S460, the merchant 22 may check the digital currency ledger to see if the operation data has been included in a block. The merchant 22 may utilise the recipient flag (rf) for this purpose, if the operation data includes a recipient flag (rf). Because the operation data will have been added to the digital currency ledger in a block approved by a trusted verifier, the merchant 22 may very quickly satisfy themselves that the operation data has been added to the digital currency ledger and can be relied upon by authenticating the verification data 330 in the block. Thus, unlike in other digital currency systems, it is not necessary for a large number of subsequent blocks to have been added to the digital currency ledger in order to trust the block comprising the operation date (which can take about an hour), thereby saving considerable time in completing the transaction. Furthermore, it is not necessary for the merchant 22 to check the validity of the operation data for themselves, which again saves considerable time and reduces data processing requirements as they do not need to review the entire digital currency ledger. Furthermore, security may be enhanced because the operation data can only have been correctly verified by a trusted verifier, thus eliminating the risk of a rogue miner verifying a transaction that should not have been verified.

If the merchant 22 is satisfied that the operation data is in the digital currency ledger so that the transfer has taken place, they may confirm to the customer 21 that the transaction has taken place (for example, by presenting a success page in an on-line transaction, or by aurally confirming in the case of a face-to-face purchase, etc) and provide the product to the customer 21 (for example, by shipping it, or by handing over the product). Optionally, the customer 21 may also check the digital currency ledger for themselves to check that the transfer has taken place.

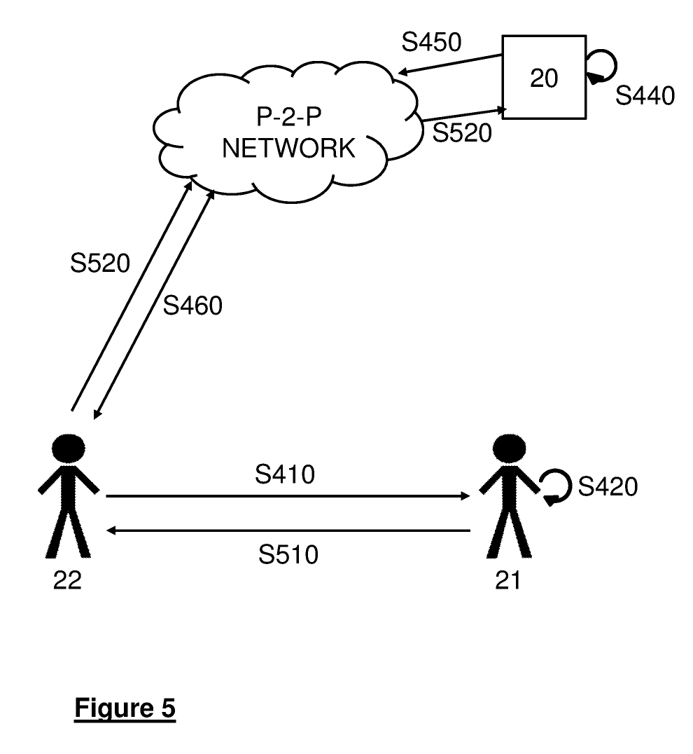

FIG. 5 shows a further example of a customer (payer) 21 wishing to purchase a product from a merchant (payee) 22. This example is very similar to that of FIG. 4, but in this example the customer 21 does not have a connection to the network 200 (for example, because they are in the merchant's shop and do not have a data connection on their electronic device).

Steps S410 and S420 are performed as described above. After performing the operation, because the customer 21 cannot connect to the network 200, in Step 510 they communicate the operation data to the merchant 22 using any suitable local data connection to the merchant's electronic device (for example, via Bluetooth, NFC, display of a visual code, for example a QR code, IR, etc). In Step S520, the merchant 22 communicates the operation data to at least one verification entity 20 in the network 200 as described above.

Steps S440, S450 and S460 are performed as described above. Optionally, the customer 21 may also check the digital currency ledger for themselves to check that the transfer has taken place.

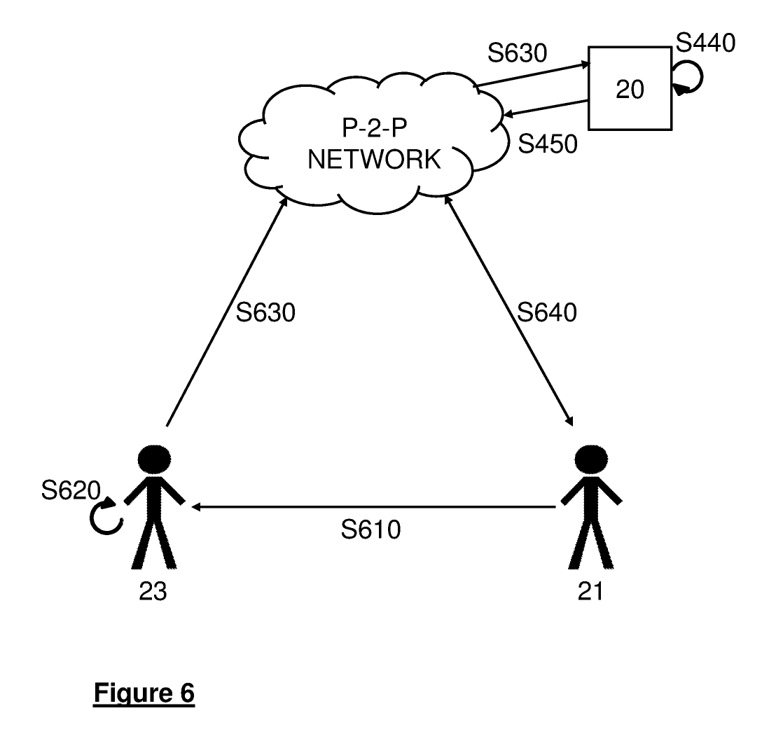

FIG. 6 shows an example of a customer 21 ‘cashing in’. In this example, the customer 21 may wish to obtain an amount of digital currency in exchange for providing some other currency (for example, fiat currency) to the exchange entity 23. The exchange entity 23 may be a bank, or a currency conversion entity, or an ordinary person who has some digital currency that they wish to exchange for some other currency. The customer 21 may be provided with the digital currency either by transferring digital currency to them (for example, where the exchange entity is a user entity 10 that owns some digital currency) or by creating digital currency using create data (for example, where the exchange entity 23 is a currency issuer 30, such as a bank).

In Step S610, the customer 21 communicates their public wallet key (pw) to the exchange entity 23 and optionally the value of digital currency that they would like. This information may be communicated in any suitable way depending on the situation. For example, if the customer 21 is at the exchange entity's premises, the customer 21 may communicate the information from the customer's electronic device to the exchange entity's electronic device using any suitable communications technology, such as Bluetooth, NFC, SMS message, email, infra-red (IR) communication, in a QR code (or any other form of visual code) that is displayed on the customer's electronic device for scanning by the exchange entity's electronic device, etc. Alternatively, if the exchange is an internet based exchange, the customer 21 may communicate the information in a QR code, or via an email, or via a digital currency portal, or a secure web-based data transfer, etc.

In Step S620 the exchange entity 23 performs the necessary operation (for example, a CREATE operation, or a TRANSFER operation) to generate the required operation data, analogously to Step S420 described above. In Step S630, the operation data is communicated to a verification entity 20, analogously to Step S430 described above.

Steps S440 and S450 are performed as described above. In Step S640, the customer 21 may check the digital currency ledger to see if the operation data has been included in a block, for example by utilising the recipient flag (rf), if the operation data includes a recipient flag (rf). Again, because the operation data will have been added to the digital currency ledger in a block approved by a trusted verifier, the customer may very quickly and with minimum data processing satisfy themselves that the operation data has been added to the digital currency ledger and can be relied upon by authenticating the verification data 330 in the block.

If the customer 21 is satisfied that the operation data is in the digital currency ledger, they may transfer the other currency to the exchange entity 23 (for example, by executing a bank transfer, or handing over cash, etc). Optionally, the exchange entity 23 may also check the digital currency ledger to check that the transfer has taken place.

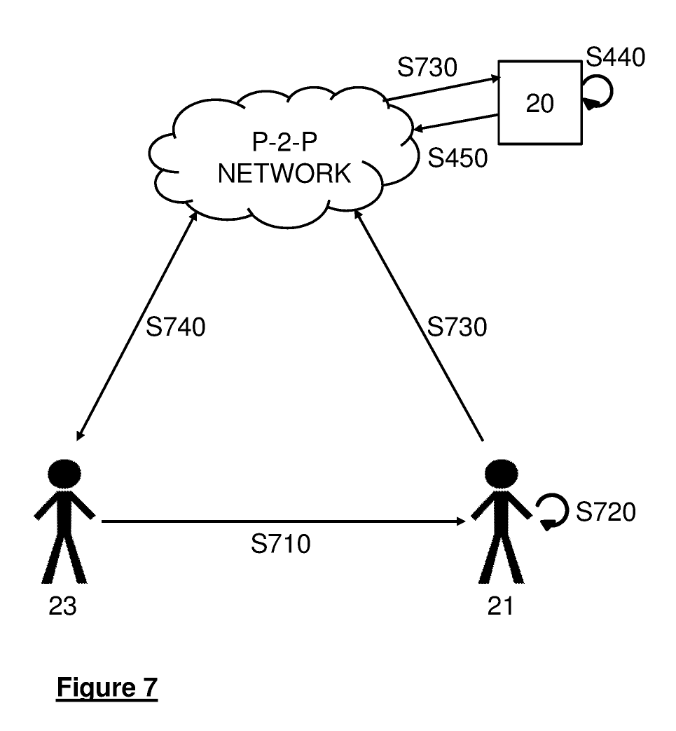

FIG. 7 shows an example of a customer 21 ‘cashing out’. In this example, the customer 21 may wish to exchange an amount of digital currency for some other currency (for example, fiat currency) from an exchange entity 23. The exchange entity 23 may be a bank, or a currency conversion entity, or an ordinary person who has some other currency that they wish to exchange for some digital currency. The customer's digital currency may be destroyed (for example, where the exchange entity 23 is a currency destroyer 34, such as a bank) or transferred to the exchange entity 23 (for example, where the exchange entity is a user entity 10 that owns some digital currency).

In Step S710, the exchange entity 23 communicates their public wallet key (pw) to the customer 21. This information may be communicated in any suitable way depending on the situation. For example, if the customer 21 is in the exchange entity's premises, the exchange entity 23 may communicate the information from their electronic device to the customer's electronic device using any suitable communications technology, such as Bluetooth, NFC, SMS message, email, infra-red (IR) communication, in a QR code (or any other form of visual code) that is displayed on the exchange entity's electronic device for scanning by the customer's electronic device, etc. Alternatively, if the exchange is an internet based exchange, the exchange entity 23 may communicate the information in a QR code on a check-out page, or via an email, or via a digital currency payment portal in the check-out page, etc.

Upon receipt of the information, in Step S720 the customer 21 performs the necessary operation. For example, the information may be imported into the digital currency software operating on the customer's electronic device (for example, because the customer 21 has scanned the QR code using their software, or because the information is arranged so as to launch the digital currency software with the information imported into it, etc) and the operation data may be created as described above. The electronic currency software may perform a TRANSFER, or TRANSFER&SPLIT, or TRANSFER& JOIN, TRANSFER& JOIN&SPLIT operation as necessary, depending on the amounts of digital currency that the customer 21 has and the value that they would like to ‘cash-out’.

In step S730, the operation data is communicated to at least one verification entity 20 in the network 200 as described above. In an alternative, the operation data may be communicated back to the exchange entity 23, who may in turn communicate the operation data to the verification entity 20 (analogously to the process described in respect of FIG. 5 above). Steps S440 and S450 are performed as described above.

In Step S740, the exchange entity 23 may check the digital currency ledger to see if the operation data has been included in a block. The exchange entity 23 may utilise the recipient flag (rf) for this purpose, if the operation data includes a recipient flag (rf). Again, because the operation data will have been added to the digital currency ledger in a block approved by a trusted verifier, the exchange entity 23 may very quickly and with minimum data processing satisfy themselves that the operation data has been added to the digital currency ledger and can be relied upon by authenticating the verification data 330 in the block.

If exchange entity 23 is satisfied that the operation data is in the digital currency ledger so that the transfer has taken place, they may confirm to the customer 21 that the transaction has taken place (for example, by presenting a success page in an on-line transaction, or by aurally confirming in the case of a face-to-face purchase, etc) and provide the other digital currency to the customer 21 (for example, executing a bank transfer, or handing over cash, etc). Optionally, the customer 21 may also check the digital currency ledger for themselves to check that the transfer has taken place.

Once the exchange entity 23 has the amount of digital currency, they may either keep hold of the amount, or if they are a currency destroyer 40, they may destroy the amount of digital currency.

It will be appreciated from the above description that the units of digital currency may be set to any form of currency unit (for example, it may be set to a unit of fiat currency, such as US dollars, Euros, Pounds Sterling, etc), such that the digital currency represents an alternative way of keeping and spending fiat currency. This may have advantages in that the digital currency will not fluctuate in value against the fiat currency to which it is set. It also means that when a user ‘cashes out’ of the digital currency system (for example, they exchange their amount of digital currency for an amount of fiat currency in a different currency system, for example the cash system), a bank may perform the exchange for them as described above and then destroy the amount of digital currency system. In this way, a balance may always be kept between the total value of currency in the digital currency system and the total value of currency in other currency systems (i.e., the total value in all currency systems may be kept the same).

Various alternatives to the above described aspects may be readily appreciated.

For example, the network 200 may comprise user entities 10 and the primary authority 50. The primary authority may have the authority to create and destroy digital currency and to verify operation data from the user entities 10 (i.e. the primary authority 50 would be a currency creator, a currency destroyer and a verifier). This may be of use where an entity, such as a bank, wishes to exercise complete control over the entire digital currency system. Optionally, the network 200 may also comprise at least one of a currency creator 30, currency destroyer 40 and a verification entity 20 (for example, where the primary authority 50 wishes to delegate those powers to at least one other entity).

There may be more than one primary authority 50, with each primary authority having responsibility for managing a particular set of user entities 10 and/or currency issuers 20 and/or currency destroyers 30 and/or verification entities 40. Each example, each primary authority 50 may be a different bank, each responsible for managing the user entities 10 that bank with them (for example, maintaining their tracking keys and monitoring the amounts going into and out of their wallets, and/or dealing with user queries, etc). All primary authorities may have the same privileges, or different primary authorities may have different privileges, such that they are authorised to carry out different activities.

Where there is only one currency issuer 30 and/or currency destroyer 40 and/or verification entity 20 (for example, because the primary authority 50 is the only entity that can perform these operations) it may not be necessary to include an identifier of the currency issuer 30 and/or currency destroyer 40 and/or verification entity 20 in the operation data that they generate. This is because there will be only one issuer public key (pb) and/or destroyer public key (pd) and/or verifier public key (pv), so an identifier of the currency issuer 30 and/or currency destroyer 40 and/or verification entity 20 would not be required in order to look up the correct key. In the above, the network 200 is configured to operate as a P2P network. In this case, the digital currency ledger may be maintained by virtue of P2P sharing (for example, broadcasting of operation data and/or new blocks to the entire P2P network). However, the network 200 may be configured in any suitable way. For example, all operation data from user entities 10 may be communicated to the primary authority 50. The primary authority 50 may then verify the operation data and add it to the digital currency ledger, or forward it to a verification entity 20 who may then verify it and add it to the digital currency ledger by passing it back to the primary authority 50 or broadcasting it to the network 200. Thus, it is possible for the primary authority 50 to keep and update the digital currency ledger themselves, and simply make it available to other entities in the network 200 by broadcasting it, or keeping it in a publically accessible location in the network 200.

Any entity in the network 200 may be configured to be able to perform multiple functions. For example, an entity may be configured as a currency creator, a currency destroyer and a verification entity, or another entity may be configured as a currency creator and a verification entity, etc. The network 200 may comprise any number of different entities, each of which may be configured to perform one or more of the functions described above. In this instance, where an entity is configured to perform two or more functions, their public key may be used to verify operation data that they generate for either function (for example, a single public key may be used to verify create data and destroy data generated by an entity that is configured to perform create and destroy functions).

Any number of public keys may be included in the digital currency software and/or added into the digital currency software by way of update. In this instance, each public key may be stored with an associated identifier to the entity to which the public key relates, so that the entity operating the software may look up the correct public key to perform verification on operation data.

Operation data may comprise an identifier of the type of operation to which it relates (for example, a CREATE operation, or TRANSFER operation, etc). Alternatively, it may not comprise such an identifier. In this instance, it may be recognised from the contents of the operation data to which type of operation it relates (for example, if there is no Input data, it relates to a DESTROY operation, or if there is a recipient flag (rf) it is a TRANSFER operation, etc).

Many combinations, modifications, or alterations to the features of the above embodiments will be readily apparent to the skilled person and are intended to form part of the invention. Any of the features described specifically relating to one embodiment or example may be used in any other embodiment by making the appropriate changes.

It will be appreciated that the methods described have been shown as individual steps carried out in a specific order. However, the skilled person will appreciate that these steps may be combined or carried out in a different order whilst still achieving the desired result.

It will be appreciated that embodiments of the invention may be implemented using a variety of different information processing systems. In particular, although the figures and the discussion thereof provide an exemplary computing system and methods, these are presented merely to provide a useful reference in discussing various aspects of the invention. It will be appreciated that the boundaries between logic blocks are merely illustrative and that alternative embodiments may merge logic blocks or elements, or may impose an alternate decomposition of functionality upon various logic blocks or elements.

It will be appreciated that the above-mentioned functionality may be implemented as one or more corresponding software modules or components. Method steps implemented in flowcharts contained herein, or as described above, may each be implemented by corresponding respective modules; multiple method steps implemented in flowcharts contained herein, or as described above, may together be implemented by a single module.

It will be appreciated that, insofar as embodiments of the invention are implemented by software (or a computer program), then a storage medium and a transmission medium carrying the computer program form aspects of the invention. The computer program may have one or more program instructions, or program code, which, when executed by a computer carries out an embodiment of the invention. The term “program” or “software” as used herein, may be a sequence of instructions designed for execution on a computer system, and may include a subroutine, a function, a procedure, a module, an object method, an object implementation, an executable application, an applet, a servlet, source code, object code, a shared library, a dynamic linked library, and/or other sequences of instructions designed for execution on a computer system. The storage medium may be a magnetic disc (such as a hard drive or a floppy disc), an optical disc (such as a CD-ROM, a DVD-ROM or a BluRay disc), or a memory (such as a ROM, a RAM, EEPROM, EPROM, Flash memory or a portable/removable memory device), etc. The transmission medium may be a communications signal, a data broadcast, a communications link between two or more computers, etc.

1. A method for creating an amount of digital currency, the method comprising:
generating a currency create signature by cryptographically signing currency data using at least a currency creator secret key; and
generating verifiable create data suitable for addition to a digital currency ledger, wherein the create data comprises the currency data and the currency create signature, the currency data comprising:
a value of the amount of new digital currency; and
currency key data based at least in part on a currency public key, wherein the currency public key corresponds to the amount of digital currency.

2. The method of claim 1, further comprising:
outputting the create data for provision to a verification entity to enable the verification entity to add the create data to the digital currency ledger.

3. The method of claim 1, further comprising:
generating a new block comprising the create data; and
adding the new block in the digital currency ledger.

4. The method of any preceding claim, further comprising:
generating the currency public key.

5. The method of any preceding claim, wherein the currency key data comprises a hash of the currency public key.

6. The method of any preceding claim, wherein a currency creator public key corresponding to the currency creator private key is obtainable by a verification entity.

7. The method of any preceding claim, wherein a currency creator pubic key corresponding to the currency creator private key is obtainable by at least one entity in a network of digital currency entities.

8. An electronic device for performing a create operation to create an amount of new digital currency, the electronic device comprising:
a processor; and
a memory storing a software program, wherein the software program, when executed by the processor, causes the processor to perform the method of any preceding claim.

9. A software program configured to perform the method of any of claims 1 to 7, when executed on a processor of an electronic device.

10. A method for verifying create data for creating digital currency, the create data comprising currency data and a currency create signature, the method comprising a verification entity:
obtaining a currency creator public key; and
performing a verification process on the currency create signature using at least the currency data and currency creator public key.

11. The method of claim 10, wherein the currency creator public key is obtained from a key block chain or from memory in the verification entity.

12. The method of either claim 10 or claim 11, further comprising:
if the outcome of the verification process is a positive verification of the currency signature, adding the create data to a digital currency ledger; and
if the outcome of the verification process is a negative verification of the currency signature, discarding the create data.

13. The method of claim 12, wherein adding the create data to the digital currency ledger comprises:
generating a verifier signature using at least a verifier secret key;
generating verification data comprising an identifier of the verification entity and the verifier signature;
generating a new block comprising the create data and the verification data; and
adding the new block in the digital currency ledger.

14. The method of claim 13, wherein generating the verifier signature comprises cryptographically signing at least the identifier of the verification entity using the verifier secret key.

15. The method of claim 13 or claim 14, wherein a verifier public key corresponding to the verifier private key is obtainable by at least one entity in a network of digital currency entities.

16. A verification entity comprising:
a processor; and
a memory storing a software program, wherein the software program, when executed by the processor, causes the processor to perform the method of any of claims 10 to 15.

17. A software program configured to perform the method of any of claims 8 to 13, when executed on a processor of a verification entity.

18. A method for destroying an amount of digital currency, the method comprising:
generating a currency destroy signature by cryptographically signing currency data using at least a currency destroyer secret key; and
generating verifiable destroy data suitable for addition to a digital currency ledger, wherein the destroy data comprises the currency data and the currency destroy signature, wherein the currency data comprises:
currency key data based at least in part on a currency public key associated with the amount of digital currency.

19. The method of claim 18, further comprising:
outputting the destroy data for provision to a verification entity to enable the verification entity to add the destroy data to the digital currency ledger.

20. The method of claim 18, further comprising:
generating a new block comprising the destroy data; and
adding the new block in the digital currency ledger.

21. The method of any of claims 18 to 20, further comprising:
recording a value of the amount of digital currency and the currency key data.

22. The method of any of claims 18 to 21, wherein the currency key data comprises a hash of the currency public key.

23. The method of any of claims 18 to 22, wherein a currency destroyer public key corresponding to the currency destroyer secret key is obtainable by at least one entity in a network of digital currency entities

24. The method of claim 23, wherein the currency destroyer pubic key is obtainable from a public key block chain or from memory in the at least one entity.

25. An electronic device for destroying an amount of digital currency, the electronic device comprising:
a processor; and
a memory storing a software program, wherein the software program, when executed by the processor, causes the processor to perform the method of any of claims 18 to 24.

26. A software program configured to perform the method of any of claims 18 to 24, when executed on a processor of an electronic device.

27. A method for verifying destroy data for destroying an amount of digital currency, the destroy data comprising currency data and a currency destroy signature, the method comprising a verification entity:
obtaining a currency destroyer public key; and
performing a verification process on the currency destroy signature using at least the currency data and currency destroyer public key.

28. The method of claim 27, wherein the currency destroyer public key is obtained from a key block chain or from memory in the verification entity.

29. The method of either claim 27 or claim 28, further comprising:
if the outcome of the verification process is a positive verification of the currency destroy signature, adding the destroy data to a digital currency ledger; and
if the outcome of the verification process is a negative verification of the currency destroy signature, discarding the destroy data.

30. The method of claim 29, wherein adding the destroy data to the digital currency ledger comprises:
generating a verifier signature using at least a verifier private key;
generating verification data comprising an identifier of the verification entity and the verifier signature;
generating a new block comprising the destroy data and the verification data; and
adding the new block to the digital currency ledger.

31. The method of claim 30, wherein generating the verifier signature comprises cryptographically signing at least the identifier of the verification entity using the verifier private key.

32. The method of claim 30 or claim 31, wherein a verifier public key corresponding to the verifier private key is obtainable by at least one entity in a network of digital currency entities.

33. A verification entity comprising:
a processor; and
a memory storing a software program, wherein the software program, when executed by the processor, causes the processor to perform the method of any of claims 27 to 32.

34. A software program configured to perform the method of any of claims 27 to 32, when executed on a processor of a verification entity.

35. A method for verifying digital currency operation data comprising currency data and a signature based at least in part on the currency data, the method comprising a verification entity performing the steps of:
performing a verification process on the currency data using at least the signature; and
if the outcome of the verification process is a positive verification:
generating verification data comprising a verification signature;
generating a new block comprising the digital currency operation data and the verification data; and
adding the new block to a digital currency ledger.

36. The method of claim 35, wherein the digital currency operation data is create data or destroy data, and wherein the public key associated with the digital currency operation is a public key associated with the entity that generated the digital currency operation data, the method further comprising:
obtaining the public key, and the verification process comprises:
decrypting the signature using at least the public key; and
comparing the decrypted signature with the digital currency operation data.

37. The method of claim 36, wherein the public key is obtained from a key block chain or from memory in the verification entity.

38. The method of any of claims 35 to 37, wherein the digital currency ledger comprises at least one historic block, each historic block comprising historic digital currency operation data identifying at least one output amount of digital currency, the method further comprising:
setting in the new block an oldest active block identifier, wherein the oldest active block identifier identifies the oldest historic block that has historic digital currency operation data identifying at least one output amount of digital currency that is not identified in the digital currency operation data in any subsequent block in the digital currency ledger.

39. The method of any of claims 35 to 38, wherein the digital currency ledger comprises at least one historic block, each historic block comprising historic digital currency operation data, the method further comprising:
copying the historic digital currency operation data of at least one historic block into the new block.

40. A method for maintaining a digital currency ledger, the digital currency ledger comprising at least one historic block, each historic block comprising historic digital currency operation data identifying at least one output amount of digital currency, the method further comprising:
determining the oldest active block, wherein the oldest active block is the historic block that has historic digital currency operation data identifying at least one output amount of digital currency that is not identified in the digital currency operation data in any subsequent block in the digital currency ledger;
generating a new block comprising an oldest active block identifier, wherein the oldest active block identifies the determined oldest active block; and
adding the new block to the digital currency ledger.

41. The method of claim 40, further comprising:
copying the historic digital currency operation data of the determined oldest active block into the new block.

42. A method for maintaining a digital currency ledger, the digital currency ledger comprising at least one historic block, each historic block comprising historic digital currency operation data identifying at least one output amount of digital currency, the method further comprising:
generating a new block comprising a copy of historic digital currency operation data of at least one historic block; and
adding the new block to the digital currency ledger.

43. The method of claim 42, wherein the new block comprises an oldest active block identifier, the method further comprising:
determining the oldest active block, wherein the oldest active block is the historic block that has historic digital currency operation data identifying at least one output amount of digital currency that is not identified in the digital currency operation data in any subsequent block in the digital currency ledger; and
setting the identifier of the oldest active block to identify the determined oldest active block.

44. An electronic device comprising:
a processor; and
a memory storing a software program, wherein the software program, when executed by the processor, causes the processor to perform the method of any of claims 35 to 43.

45. A software program configured to perform the method of any of claims 35 to 43, when executed on a processor of an electronic device.

46. A method for maintaining a digital currency ledger, the digital currency ledger comprising at least one block of digital currency operation data, wherein the most recent of the at least one block comprises an identifier of the oldest active block, the method comprising:
communicating at least part of the digital currency ledger to a network of digital currency entities, wherein the at least part of the digital currency ledger comprises the block identified by the identifier of the oldest active block and each subsequent block.

47. The method of claim 46, wherein communicating at least part of the digital currency ledger to the network of digital currency entities comprises storing the at least part of the digital currency ledger in a location accessible to the network of digital currency entities.

48. An electronic device comprising:
a processor; and
a memory storing a software program, wherein the software program, when executed by the processor, causes the processor to perform the method of either of claim 46 or 47.

49. A software program configured to perform the method of either of claim 46 or 47, when executed on a processor of an electronic device.

50. A method for obtaining a digital currency ledger, the digital currency ledger comprising at least one block of digital currency operation data, wherein the most recent of the at least one block comprises an identifier of the oldest active block, the method comprising:
obtaining at least part of the digital currency ledger from a digital currency entity in a network of digital currency entities, wherein the at least part of the digital currency ledger comprises the block identified by the identifier of the oldest active block and each subsequent block.

51. The method of claim 50, wherein obtaining at least part of the digital currency ledger from a digital currency entity in a network of digital currency entities comprises:
obtaining the most recent block in the digital currency ledger;
identifying the oldest active block using at least the identifier of the oldest active block; and
obtaining the oldest active block and all subsequent blocks.

52. An electronic device comprising:
a processor; and
a memory storing a software program, wherein the software program, when executed by the processor, causes the processor to perform the method of either of claim 50 or 51.

53. A software program configured to perform the method of either of claim 50 or 51, when executed on a processor of an electronic device.

54. A method for transferring digital currency from a first entity to a second entity, the method comprising the first entity:
obtaining wallet public key data associated with the second entity;
generating, using at least the wallet public key data, a currency public key for the amount of digital currency to be transferred to the second entity;
obtaining a recipient identifier; and
generating transfer data comprising at least the currency public key data, a value for the amount of digital currency to be transferred to the second entity and the recipient identifier.

55. The method of claim 54, wherein obtaining the recipient identifier comprises:
generating the recipient identifier based at least in part on the wallet public key data.

56. The method of claim 55, wherein the recipient identifier is generated by truncating the wallet public key data.

57. The method of claim 54, wherein obtaining the recipient identifier comprises:
receiving the recipient identifier from the second entity.

58. The method of any of claims 54 to 57, further comprising:
outputting the transfer data for provision to a verification entity to enable the verification entity to add the transfer data to a digital currency ledger.

59. The method of any of claims 54 to 58, wherein the currency public key data comprises at least one of the currency public key and/or a currency public key hash.

60. The method of any of claims 54 to 59, wherein the wallet public key data comprises at least one of a wallet public key and/or a wallet public key hash.

61. An electronic device comprising:
a processor; and
a memory storing a software program, wherein the software program, when executed by the processor, causes the processor to perform the method of any of claims 54 to 60.

62. A software program configured to perform the method of any of claims 54 to 60, when executed on a processor of an electronic device.

63. The method for transferring digital currency from a first entity to a second entity, the method comprising:
obtaining a recipient identifier;
identifying in a digital currency ledger a set of transfer data that comprises the recipient identifier, wherein the transfer data also comprises currency public key data; and
generating a currency secret key using at least: the currency public key data; and wallet secret key data corresponding to the wallet public key data.

64. The method of claim 63, wherein obtaining the recipient identifier comprises:
generating the recipient identifier based at least in part on wallet public key data.

65. The method of claim 63 or claim 64, wherein the wallet secret key data comprises at least one of the wallet secret key and/or a hash of the wallet secret key.

66. The method of claims of claims 63 to 65, wherein the currency public key data comprises at least one of the currency public key and/or a hash of the currency public key.

67. An electronic device comprising:
a processor; and
a memory storing a software program, wherein the software program, when executed by the processor, causes the processor to perform the method of any of claims 63 to 66.

68. A software program configured to perform the method of any of claims 63 to 66, when executed on a processor of an electronic device.

69. A method for maintaining a block chain for public keys, the method comprising:
generating public key data, the key block data comprising:
a public key corresponding to a private key belonging to an entity in a digital currency network; and
an identifier of the entity in the digital currency network;
generating a master signature by cryptographically signing the public key data using at least a secret master key;
generating key block data comprising at least the public key data and the master signature; and
adding the key block data and the master signature to the block chain.

70. The method of claim 69, wherein the public key data comprises an expiry data for the public key.

71. The method of claim 69 or claim 70, wherein the public key data comprises an indicator for indicating the validity of the public key, the method further comprising:
setting the indicator to indicate that the public key is invalid.

72. The method of any of claims 69 to 71, wherein the key block data further comprises at least one of:
a block number;
a time stamp; and/or
a hash of the previous block in the block chain.

73. An electronic device comprising:
a processor; and
a memory storing a software program, wherein the software program, when executed by the processor, causes the processor to perform the method of any of claims 69 to 72.

74. A software program configured to perform the method of any of claims 69 to 72, when executed on a processor of an electronic device.
